(19) United States
(12) Patent Application Publication
(10) Pub. No.: US 2025/0200105 A1
(43) Pub. Date: Jun. 19, 2025

(54) TRAINING METHOD AND APPARATUS FOR CONTENT DETECTION MODEL, AND CONTENT DETECTION METHOD AND APPARATUS

(71) Applicant: Beijing Youzhuju Network Technology Co., Ltd., Pinggu District, Beijing (CN)

(72) Inventors: Xiyu YU, Beijing (CN); Wen ZHOU, Beijing (CN); Fan ZHANG, Beijing (CN); Liangni LU, Beijing (CN)

(21) Appl. No.: 18/846,883

(22) PCT Filed: Mar. 3, 2023
(86) PCT No.: PCT/CN2023/079520

§ 371 Date: Sep. 13, 2024

(30) Foreign Application Priority Data
Mar. 17, 2022 (CN) 202210265805.3

(51) Int. Cl. G06F 16/45; G06F 16/435

(52) U.S. Cl. CPC G06F 16/45; G06F 16/435

(57) ABSTRACT

The present application discloses a training method for content detection model, content detection method and apparatus. Respective cluster centers of respective categories of content feature of multimedia data is obtained. The extracted at least one category of content feature of the second multimedia data are compared with respective cluster centers of the corresponding category of content feature to obtain a cluster center to which each category of content feature of the second multimedia data belongs. Based on this, a content feature vector of the second multimedia data is obtained. A content detection model, which can output a predict result of the behavior category of the target user account for the target multimedia data, is trained using the content feature vector of the second multimedia data, the user feature vector of the user account and a label of the behavior category of the user account for the second multimedia data.

The present application claims priority to Chinese Application No. 202210265805.3 filed on Mar. 17, 2022 to China National Intellectual Property Administration and titled “training method and apparatus for content detection model, and content detection method and apparatus”, the disclosures of which are incorporated herein by reference in their entireties.

### FIELD

The present application relates to the field of internet technology, and specifically to a training method for a content detection model, a content detection method, apparatus and device.

### BACKGROUND

After multimedia materials are uploaded by users, a large amount of multimedia data can be generated by combining multimedia materials in different ways, and then they can be published. For example, when the multimedia materials are specifically advertisement multimedia materials and the multimedia data is video data, the multimedia data specifically refers to advertisement video data. However, not all published multimedia data are liked by users. Therefore, it is necessary to determine the ones that users like from the large amount of multimedia data and analyze them to generate high-quality multimedia data that is preferred by users in the future.

Currently, the large amount of multimedia data can be first delivered and then behavior information of the user (such as clicks, likes and completion of playback) on the delivered multimedia data can be obtained. Then, the preference of the user as to the multimedia data can be evaluated based on the behavior information of the user. However, the delivery of the large amount of multimedia data will result in high delivery costs.

### SUMMARY

In view of this, the embodiments of the present application provide a training method for a content detection model, a content detection method, an apparatus and a device, which can effectively detect a behavior category of the user on multimedia data on the basis of reducing the delivery cost, so as to predict the preference of the user as to the content of the multimedia data.

To solve the above problems, the technical solutions provided in the embodiment of the present application are as follows.

A first aspect of the embodiment of the present application provides a training method for a content detection model, extracting at least one category of content feature of first multimedia data, clustering each category of content feature of the first multimedia data to obtain a plurality of cluster centers of each category of content feature; wherein the method comprises:
extracting at least one category of content feature of second multimedia data, comparing each category of content feature of the second multimedia data with respective cluster centers of a corresponding category of content feature, to obtain a cluster center to which each category of content feature of the second multimedia data belongs;
obtaining a content feature vector of the second multimedia data based on the cluster center to which each category of content feature of the second multimedia data belongs;
obtaining a user feature vector of a user account; and
training the content detection model using the content feature vector of the second multimedia data, the user feature vector of the user account and a label of a behavior category of the user account for the second multimedia data, wherein the content detection model is used to output a prediction result of a behavior category of a target user account for target multimedia data.

A second aspect of the embodiment of the present application provides a content detection method, wherein the method comprises:
extracting at least one category of content feature of the target multimedia data, and comparing each category of content feature of the target multimedia data with respective cluster centers of a corresponding category of content feature, to obtain a cluster center to which each category of content feature of the target multimedia data belongs;
obtaining a content feature vector of the target multimedia data based on the cluster center to which each category of content feature of the target multimedia data belongs;

obtaining a user feature vector corresponding to a target user account; and
inputting the content feature vector of the target multimedia data and the user feature vector of the target user account into a content detection model, to obtain a prediction result of a behavior category of the target user account for the target multimedia data, wherein the content detection model is trained by the training method for the content detection model mentioned above.

A third aspect of the embodiment of the present application provides a training apparatus for a content detection model comprising:
a first extraction unit, configured to extract at least one category of content feature of first multimedia data, and cluster each category of content feature of the first multimedia data to obtain a plurality of cluster centers of each category of content feature;
a second extraction unit, configured to extract at least one category of content feature of second multimedia data, and compare each category of content feature of the second multimedia data with respective cluster centers of a corresponding category of content feature to obtain a cluster center to which each category of content feature of the second multimedia data belongs;
a first obtaining unit, configured to obtain a content feature vector of the second multimedia data based on the cluster center to which each category of content feature of the second multimedia data belongs;
a second obtaining unit, configured to obtain a user feature vector of a user account; and
a training unit, configured to train the content detection model using the content feature vector of the second multimedia data, the user feature vector of the user account, and a label of behavior category of the user account for the second multimedia data, wherein the content detection model is used to output a prediction result of a behavior category of a target user account for the target multimedia data.

A fourth aspect of the embodiment of the present application provides a content detection apparatus comprising:
an extraction unit, configured to extract at least one category of content feature of target multimedia data, and compare each category of content feature of the target multimedia data with respective cluster centers of a corresponding category of content feature to obtain a cluster center to which each category of content feature of the target multimedia data belongs;
a first obtaining unit, configured to obtain a content feature vector of the target multimedia data based on the cluster center to which each category of content feature of the target multimedia data belongs;
a second obtaining unit, configured to obtain a user feature vector corresponding to a target user account; and
a first input unit, configured to input the content feature vector of the target multimedia data and the user feature vector of the target user account into a content detection model, to obtain a prediction result of the behavior category of the target user account for the target multimedia data, wherein the content detection model is trained by the training method for the content detection model mentioned above.

A fifth aspect of the embodiment of the present application provides an electronic device comprising:
one or more processors; and
a storage storing one or more programs thereon which, when executed by the one or more processors cause the one or more processors to implement the training method for the content detection model mentioned above or the content detection method mentioned above.

A sixth aspect of the embodiment of the present application provides a computer-readable medium having a computer program stored thereon that, when executed by a processor, implements the training method for the content detection model mentioned above or the content detection method mentioned above.

A seventh aspect of the embodiment of the present application provides a computer program product that, when running on a computer, causes the computer to implement the training method for the content detection model mentioned above or the content detection method mentioned above.

It can be seen that the embodiments of the present application have the following benefits:

The embodiment of the present application provides a training method for a content detection model, a content detection method, an apparatus and a device. First, at least one category of content feature of first multimedia data is extracted, each category of content feature of the first multimedia data is clustered, and a plurality of cluster centers of each category of content feature are obtained. Then, after extracting at least one category of content feature of second multimedia data, each category of content feature of the second multimedia data is compared with respective cluster centers of a corresponding category of content feature, to obtain the cluster center to which each category of content feature of the second multimedia data belongs. A content feature vector of the second multimedia data is obtained based on the cluster center to which each category of content feature of the second multimedia data belongs. The content detection model is trained using the obtained content feature vector of the second multimedia data, the obtained user feature vector of the user account, and a label of behavior category of the user account for the second multimedia data. This enables the trained content detection model to output the predict result of the behavior category of the target user account for the target multimedia data. In this way, the content detection model can be used to predict the behavior category of the user for multimedia data without delivering multimedia data, and then the degree of the preference of the user for multimedia data can be analyzed.

### BRIEF DESCRIPTION OF THE DRAWINGS

FIG. 1 is a schematic framework diagram of an exemplary application scenario provided by the embodiment of the present application;

FIG. 2 is a flow chart of a training method for a content detection model provided by the embodiment of the present application;

FIG. 3a is a schematic diagram of clustering a first multimedia data provided by the embodiment of the present application;

FIG. 3b is a schematic diagram of clustering a second multimedia data provided by the embodiment of the present application;

FIG. 4a is a schematic diagram of a content detection model provided by the embodiment of the present application;

FIG. 4b is a schematic diagram of another content detection model provided by the embodiment of the present application;

FIG. 5a is a schematic diagram of another content detection model provided by the embodiment of the present application;

FIG. 5b is a schematic diagram of another content detection model provided by the embodiment of the present application;

FIG. 6 is a schematic framework diagram of another exemplary application scenario provided by the embodiment of the present application;

FIG. 7 is a flow chart of a content detection method provided by the embodiment of the present application;

FIG. 8 is a schematic diagram of training a user account recall model provided by the embodiment of the present application;

FIG. 9 is a schematic structural diagram of a training apparatus for a content detection model provided by the embodiment of the present application;

FIG. 10 is a schematic structural diagram of a content detection apparatus provided by the embodiment of the present application;

FIG. 11 is a schematic structural diagram of an electronic device provided by the embodiment of the present application.

### DETAILED DESCRIPTION OF EMBODIMENTS

In order to make the above objects, features and advantages of the present application more obvious and understandable, the embodiment of the present application will be further described in detail below in conjunction with the accompanying drawings and detailed description of embodiments.

In order to facilitate understanding and explanation of the technical solutions provided by the embodiment of the present application, the background of the present application will be described below.

After multimedia materials are uploaded by users, a large amount of multimedia data can be generated automatically by combining multimedia materials in different ways, and then they can be published. However, not all published multimedia data are liked by users. Therefore, it is necessary to determine the ones that users like from the large amount of multimedia data and analyze them to generate high-quality multimedia data that is preferred by users in the future.

As an optional example, when the multimedia material is specifically an advertisement multimedia material and the multimedia data is video data, the advertisement multimedia material specifically refers to the advertisement video material, and the multimedia data specifically refers to the advertisement video data (hereinafter referred to as advertisement video). Specifically, users will evaluate the advertisement video through incentive behaviors (such as clicks, likes, and completion of playback) defined by a platform. When a click conversion rate, a number of likes, or a rate of completion of playback is high, it can be determined that the advertisement video is a high-quality video, and the advertisement video material in the advertisement video is a high-quality advertisement video material. Otherwise, it is a low-quality advertisement video and advertisement video material. After determining the high-quality advertisement video material, a higher-quality advertisement video can be generated later. At present, a large amount of multimedia data can be delivered first, and then the behavior information of the user (such as clicks, likes, and completion of playback, etc.) on the delivered multimedia data can be obtained. Then, the preference of the user as to the multimedia data is evaluated based on the behavior information of the user. However, the delivery of the large amount of multimedia data will result in high delivery costs.

Based on this, the embodiment of the present application provides a training method for a content detection model, a content detection method, an apparatus and a device. First, at least one category of content feature of the first multimedia data is extracted, each category of content feature of the first multimedia data are clustered, and a plurality of cluster centers of each category of content feature are obtained. Then, after extracting at least one category of content feature of the second multimedia data, each category of content feature of the second multimedia data is compared with respective cluster centers of a corresponding category of content feature, to obtain the cluster center to which each category of content feature of the second multimedia data belongs. The content feature vector of the second multimedia data is obtained based on the cluster center to which each category of content feature of the second multimedia data belongs. The content detection model is trained using the obtained content feature vector of the second multimedia data, the user feature vector of the user account, and the label of behavior category of the user account for the second multimedia data. This enables the trained content detection model to output the predict result of the behavior category of the target user account for the target multimedia data. In this way, the content detection model can be used to predict the behavior category of the user for multimedia data without delivering multimedia data, and then the degree of the preference of the user for multimedia data can be analyzed

It should be noted that, in the embodiment of the present application, the user feature vector of the user account and the label of behavior category of the user account for the second multimedia data do not involve sensitive information on the user. And the user feature vector of the user account and the label of behavior category of the user account for the second multimedia data are obtained and used after authorizing by the user. In one example, before obtaining the user feature vector of the user account and the label of behavior category of the user account for the second multimedia data, a corresponding interface displays prompt information related to obtaining an authorization of using data, and the user determines whether to agree to the authorization based on the prompt information.

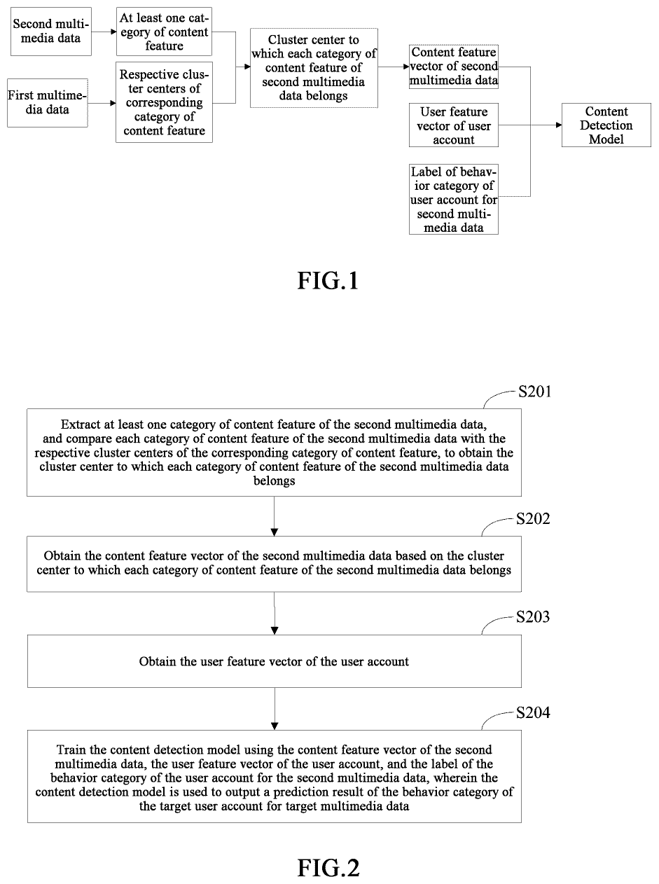

In order to facilitate understanding of the training method for the content detection model provided in the embodiment of the present application, the following is an explanation in conjunction with the scenario example shown in FIG. 1. Referring to FIG. 1, this figure is a schematic framework diagram of an exemplary application scenario provided in the embodiment of the present application.

In a practical application, at least one category of content feature of the first multimedia data is first obtained. For example, the first multimedia data comprises a title text category of data, an Optical Character Recognition (OCR) text category of data, an Automatic Speech Recognition (ASR) text category of data, or a video/image category of data. The content feature is a feature vector obtained based on the data, and different categories of data correspond to different categories of content feature, that is, correspond to different categories of feature vector. The first multimedia data is obtained by collecting the multimedia data, which can be used to determine the respective cluster centers of each category of content feature. Then, after obtaining at least one category of content feature of the first multimedia data, each category of content feature in the first multimedia data are clustered respectively to obtain a plurality of cluster centers of each category of content feature. For example, there are five cluster centers corresponding to the title text category of content feature, namely cluster centers 01, 02, 03, 04, and 05.

After obtaining the plurality of cluster centers of respective categories of content feature of each multimedia data, the content feature vector of the second multimedia data can be obtained based on the plurality of cluster centers of respective categories of content feature. In an implementation, at least one category of content feature of the second multimedia data are first extracted, and then each category of content feature in the second multimedia data are compared with the respective cluster centers of the corresponding category of content feature that have been obtained, to determine the cluster center to which each category of content feature of the second multimedia data belong. For example, the content feature of the title text category of data in the second multimedia data are compared with the 5 cluster centers that have been obtained, to determine the cluster center (such as cluster center A) to which the content feature of the title text category of data in the second multimedia data belong. Furthermore, the content feature vector of the second multimedia data is obtained, based on the cluster center to which each category of content feature of the second multimedia data belong. The content feature vector of the second multimedia data is used to train the content detection model.

In addition, the user feature vector of the user account is obtained, and the user feature vector of the user account is also used to train the content detection model. Specifically, the content feature vector of the second multimedia data, the user feature vector of the user account, and the label of behavior category of the user account for the second multimedia data are used to train the content detection model. The content detection model is used to, in the training process or after training, output the prediction result of the behavior category of the target user account for the target multimedia data.

Those skilled in the art will appreciate that the framework diagram shown in FIG. 1 is only an example in which the embodiment of the present application can be implemented. The scope of the embodiment of the present application is not limited by any aspect of the framework.

To facilitate understanding of the present application, a training method for a content detection model provided in the embodiment of the present application is described below with reference to the accompanying drawings.

Refer to FIG. 2, which is a flow chart of a training method for a content detection model provided by the embodiment of the present application. As shown in FIG. 2, the method may comprise S201-S204:
S201: at least one category of content feature of the second multimedia data is extracted, and each category of content feature of the second multimedia data is compared with respective cluster centers of a correspond category of content feature, to obtain the cluster center to which each category of content feature of the second multimedia data belongs.

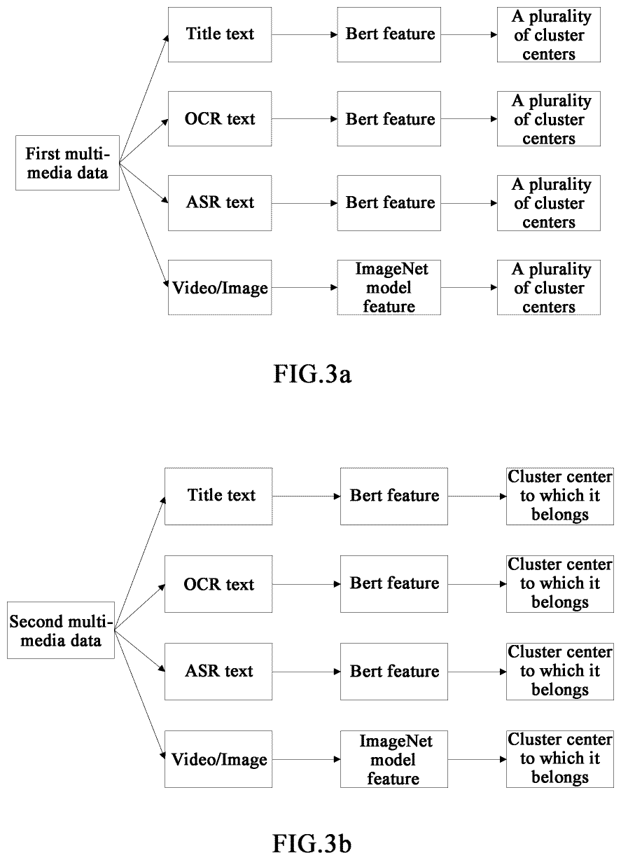

Before this step is executed, the cluster center corresponding to at least one category of content feature of the multimedia data should be first determined. As an optional example, the multimedia data is advertisement multimedia data. Referring to FIG. 3a, FIG. 3a is a schematic diagram of clustering a first multimedia data provided in the embodiment of the present application. As shown in FIG. 3a, the first multimedia data is first collected. The first multimedia data is used to determine the cluster center of the multimedia data. For example, the first multimedia data is 50 million pieces of multimedia data. As an optional example, the first multimedia data is first advertisement multimedia data.

Furthermore, at least one category of content feature of the first multimedia data is extracted. The category of the first multimedia data comprises one or more of the title text category, the OCR text category, the ASR text category, and the video/image category. In one or more embodiments, a pre-trained model may be directly used to extract at least one category of content feature of the first multimedia data, and then the extracted content feature may be transferred to the content detection model. For example, as shown in FIG. 3a, the pre-trained model is a bidirectional pre-training converter BERT model, and the corresponding extracted content feature is Bert feature. The BERT model can be used to extract the title text category of content feature, the OCR text category of content feature, and the ASR text category of content feature. In addition, the pre-trained model can also be a picture-level deep learning model. The picture-level deep learning model can be used to extract the video/image category of content feature. For example, for an image data set ImageNet based model, the extracted content feature corresponds to the ImageNet model feature. As shown in FIG. 3a, the content feature extracted from the title text category of the data corresponds to the title text Bert feature, the content feature extracted from the OCR text category of the data corresponds to the OCR text Bert feature, the content feature extracted from the ASR text category of the data corresponds to the ASR text Bert feature, and the content feature extracted from the video/image category of data corresponds to the ImageNet model feature.

Finally, each category of content feature of the first multimedia data are clustered respectively to obtain the plurality of cluster centers of each category of content feature. In one or more embodiments, the cluster centers can be represented by ID numbers or other representation forms. For example, the plurality of cluster centers of the title text category of content feature are obtained and represented as 01, 02, 03, 04, and 05. The plurality of cluster centers corresponding to the OCR text category of content feature are represented as 06, 07, and 08. The plurality of cluster centers corresponding to the ASR text category of content feature are represented as 09, 10, 11, and 12. The plurality of cluster centers corresponding to the video/image category of content feature are represented as 13, 14, and 15.

After determining the plurality of cluster centers of each category of content feature of the multimedia data, the content feature vector of the second multimedia data can be determined based thereon. Wherein the content feature vector of the second multimedia data is used to train the content detection model. It can be understood that the second multimedia data is multimedia data that has been delivered. For example, the second multimedia data is 50,000 pieces of multimedia data that has been delivered. As an optional example, the second multimedia data is second advertisement multimedia data.

In an implementation, it is necessary to first extract at least one category of content feature of the second multimedia data. Refer to FIG. 3b, which is a schematic diagram of clustering a second multimedia data provided by the embodiment of the present application. The category of the second multimedia data also comprises one or more of the title text category, the OCR text category, the ASR text category, and the video/image category. In one or more embodiments, since the second multimedia data is used to train the data of the content detection model, in order to improve the training time of the model, the pre-trained model can be directly used extract at least one category of content feature of the first multimedia data in the process of training the content detection model. For example, as shown in FIG. 3b, if the pre-trained model is a bidirectional pre-training converter BERT model or the image data set ImageNet based model, the extracted content feature corresponds to the Bert feature or the ImageNet model feature. As an optional example, on the basis that the multimedia data is the advertisement multimedia data, the content detection model is an advertisement content detection model.

Then, each category of content feature of the second multimedia data are compared with the respective cluster centers of the corresponding category of content feature, to obtain the cluster center to which each category of content feature of the second multimedia data belong. For example, the obtained content feature of the title text category of data in the second multimedia data are compared with the plurality of cluster centers of the title text category of content feature, and the cluster center to which the obtained content feature of the title text category of data belongs is A. Finally, the content feature vector of the second multimedia data is obtained through the subsequent S202.

In one or more embodiments, the dimension of the content feature extracted using the pre-trained model is usually very high. In this case, the dimension of the extracted content feature may be first reduced, and then the content feature after dimension reduce may be used for subsequent processing.
S202: the content feature vector of the second multimedia data is obtained based on the cluster center to which each category of content feature of the second multimedia data belongs.

After obtaining the cluster center to which each category of content feature of the second multimedia data belongs, the content feature vector of the second multimedia data can be obtained based on the cluster center to which each category of content feature of the second multimedia data belongs. It can be understood that, the content feature vector of the second multimedia data can be obtained through a variety of implementations, based on the cluster center to which each category of content feature of the second multimedia data belongs.

In a possible implementation, the embodiment of the present application provides an implementation of obtaining the content feature vector of the second multimedia data based on the cluster center to which each category of content feature of the second multimedia data belongs.

First, the content feature vectors corresponding to the plurality of cluster centers of each category of content feature are calculated based on each category of content feature. Secondly, the content feature vector corresponding to the cluster center to which each category of content feature of the second multimedia data belongs is determined as the content feature vector of the second multimedia data. This method directly obtains the content feature vector of the second multimedia data, without increasing the training time of the model, which can improve the training efficiency of the content detection model.

In a possible implementation, the embodiment of the present application provides an implementation of obtaining the content feature vector of the second multimedia data based on the cluster center to which each category of content feature of the second multimedia data belongs in S202. B1-B5 below are referred to for details.

S203: the user feature vector of the user account is obtained.

In one or more embodiments, the obtained user feature vector of the user account is also used to train the content detection model.

In a possible implementation, the embodiment of the present application provides an implementation of obtaining the user feature vector of the user account. The method comprises:

A1: user information of the user account is collected, and a first user feature of the user account is generated based on the user information of the user account.

Wherein the user information of the user account is used to characterize the relevant information of the user. The user information comprises the identity information of the user, the gender information of the user, the age information of the user, the province identification code (i.e., province ID) of the user, the device identification code (i.e., the device ID) to which the user account belongs, and so on.

The first user feature of the user account may be generated based on the user information of the user account. The first user feature of the user account is used to characterize the user account.

A2: the second user feature of the user account is obtained by pre-training.

In order to more accurately characterize the information of the user account, in one or more embodiments, the second user feature of the user account is obtained. The second user feature is also used to characterize the user account, which can make the representation of the user account more accurate.

As an optional example, the second user feature of the user account may be obtained by pre-training. For example, the feature of the user account is obtained from other businesses and used as the second user feature of the user.

A3: the first user feature of the user account and the second user feature of the user account are used as the user feature vector of the user account.

In one or more embodiments, the user feature vector of the user account is composed of the feature vector corresponding to the first user feature of the user account and the feature vector corresponding to the second user feature of the user account. Thus, the obtained user feature vector of the user account can more accurately characterize the user account.

It should be noted that in the embodiment of the present application, the user information of the user account, the first user feature of the user account, and the second user feature of the user account do not involve the sensitive information on the user. The user information of the user account, the first user feature of the user account, and the second user feature of the user account are obtained and used after authorization by the user. In an example, before obtaining the user information of the user account, the first user feature of the user account, and the second user feature of the user account, the corresponding interface displays prompt information related to obtaining an authorization of using data, and the user determines whether to agree to the authorization based on the prompt information.

S204: the content detection model is trained using the content feature vector of the second multimedia data, the user feature vector of the user account, and the label of behavior category of the user account for the second multimedia data. The content detection model is used to output the prediction result of the behavior category of the target user account for the target multimedia data.

After obtaining the content feature vector of the second multimedia data and the user feature vector of the user account, the label of behavior category of the user account for the second multimedia data is also obtained. It can be understood that the label of behavior category of the user account for the second multimedia data can characterize the degree of the preference of user account as to the second multimedia data. Wherein the behavior category of the user account for the second multimedia data comprise clicks, likes, or completion of playback, etc. Taking likes as an example, the label of behavior category of the user account for the second multimedia data are likes and dislikes. If the label is likes, it means that the user account prefers the multimedia data that was liked. Taking the completion of playback as an example, the label of behavior category of the user account for the second multimedia data can be determined as a specific duration based on actual needs. For example, the label is less than or equal to 45 seconds and greater than 45 seconds.

Based on this, the content detection model is trained using the content feature vector of the second multimedia data, the user feature vector of the user account, and the label of behavior category of the user account for the second multimedia data. The trained content detection model is used to output the prediction result of the behavior category of the target user account for the target multimedia data. As an optional example, on the basis that the multimedia data is the advertisement multimedia data and the content detection model is the advertisement content detection model, the target multimedia data is the target advertisement multimedia data. It is understandable that determining whether multimedia data is of high quality is not only related to the multimedia data itself, but also related to the preferences of the user account. Different user accounts may have different preferences for multimedia data. Therefore, in the process of training the content detection model, the embodiment of the present application not only uses the content feature vector of the second multimedia data, but also uses the user feature vector of the user account, and the label of behavior category of the user account for the second multimedia data. That is, in the process of training the content detection model in the embodiment of the present application, both factors of the multimedia data itself and user are considered. The trained content detection model can reflect the preferences of different user accounts for multimedia data, making the content detection more reasonable and accurate.

Since the preferences of the user account may change after a certain period of time, in one or more embodiments, the content detection model needs to be continuously retrained in the embodiment of the present application. That is, after taking a certain period of time to recollect the second multimedia data, the content detection model is retrained to improve the accuracy of the content detection model in predicting the preferences of the user account in the present.

In one or more embodiments, the content detection model can be trained with a plurality of labels, that is, the user account has a plurality of labels of behavior category for the second multimedia data, such as clicks, likes, and completion of the playback labels. In other embodiments, a click-based evaluation model can be trained based on the label of the behavior category for the clicks, a like-based evaluation model can be trained based on the label of the behavior category for the likes, and the completion of the playback-based evaluation model can be trained based on the label of the behavior category for the completion of the playback. Finally, the content detection model is composed of the click-based evaluation model, the like-based evaluation model, and the completion of the playback-based evaluation model.

In some possible implementations, the embodiment of the present application provides an implementation of training the content detection model using the content feature vector of the second multimedia data, the user feature vector of the user account, and the label of behavior category of the user account for the second multimedia data, which is referred to in C1-C3 and D1-D4 below, for details.

Based on the content of S201-S204, the embodiment of the present application provides a training method for a content detection model. First, at least one category of content feature of first multimedia data is extracted, each category of content feature of the first multimedia data is clustered, and a plurality of cluster centers of each category of content feature are obtained. Then, after at least one category of content feature of second multimedia data is extracted, each category of content feature of the second multimedia data is compared with respective cluster centers of a corresponding category of content feature, to obtain the cluster center to which each category of content feature of the second multimedia data belongs. A content feature vector of the second multimedia data is obtained based on the cluster center to which each category of content feature of the second multimedia data belongs. The content detection model is trained using the obtained content feature vector of the second multimedia data, the obtained user feature vector of the user account, and a label of behavior category of the user account for the second multimedia data. This enables the trained content detection model to output the predict result of the behavior category of the target user account for the target multimedia data. In this way, the content detection model can be used to predict the behavior category of the user for multimedia data without delivering multimedia data, and then the degree of the preference of the user for multimedia data can be analyzed.

It can be understood that the above S202 provides an implementation of directly determining the content feature vector corresponding to the cluster center to which each category of content feature of the second multimedia data belongs to, as the content feature vector of the second multimedia data. Since the content feature vector obtained in this way is directly extracted from a pre-trained model, there will generally be overfitting, so that the obtained content feature vector of the second multimedia data cannot accurately characterize the second multimedia data.

Based on this, in a possible implementation, the embodiment of the present application provides another implementation of obtaining the content feature vector of the second multimedia data, based on the cluster center to which each category of content feature of the second multimedia data belongs in S202. The method comprises:

B1: the initial content feature vector corresponding to the cluster center to which each category of content feature of the second multimedia data belongs is obtained.

After determining the cluster center to which each category of content feature of the second multimedia data belongs, the initial content feature vector corresponding to the cluster center to which each category of content feature of the second multimedia data belongs is set. The initial content feature vector is the initial value of the content feature vector corresponding to the cluster center, and the initial content feature vector can be determined randomly. For example, the cluster center to which the title text category of content feature of the second multimedia data belongs is 01, and the set initial content feature vector is represented by a1. The cluster center to which the OCR text category of content feature belongs is 06, and the set initial content feature vector is represented by b1. The cluster center to which the ASR text category of content feature belongs is 09, and the set initial content feature vector is represented by c1. The cluster center to which the video/image category of content feature belongs is 13, and the set initial content feature vector is represented by d1.

B2: the initial content feature vector corresponding to the cluster center to which each category of content feature of the second multimedia data belongs is determined as the content feature vector of the second multimedia data.

Furthermore, before training the content detection model, the initial content feature vector corresponding to the cluster center to which each category of content feature of the second multimedia data belongs is determined as the content feature vector of the second multimedia data, for training the content detection models. It can be considered that the content feature vector of the second multimedia data is obtained based on the content feature vector corresponding to the cluster center to which each category of content feature of the second multimedia data belongs. In addition, the content feature vector of the second multimedia data is adjusted with the training of the content detection model, which is specifically referred to in B3-B4.

In one or more embodiments, concat operation is performed on the initial content feature vector corresponding to the cluster center to which each category of content feature of the second multimedia data belongs, and the feature vector after concat operation is the content feature vector of the second multimedia data. For example, the content feature vector of the second multimedia data is (a1, b1, c1, d1).

Based on the contents of B1-B2, the training method for the content detection model provided in the embodiment of the present application also comprises:

B3: during the process of training the content detection model, the content feature vector of the second multimedia data is adjusted.

After B2, in the process of training the content detection model, the content feature vector of the second multimedia data will be adjusted along with the iterative training of the content detection model. Because the content feature vector of the second multimedia data is obtained based on the content feature vector corresponding to the cluster center to which each category of content feature of the second multimedia data belongs, then the content feature vector corresponding to the cluster center to which each category of the content feature currently belongs can be re-determined based on the adjusted content feature vector of the second multimedia data. That is, the content feature vector corresponding to the cluster center to which each category of content feature belongs is also adjusted accordingly. For example, the adjusted content feature vector of the second multimedia data is (a2, b2, c2, d2). The adjusted content feature vectors corresponding to the cluster centers (i.e. 01, 06, 09 and 13) to which each category of content features belongs are a2, b2, c2 and d2, respectively.

B4: the adjusted content feature vector corresponding to the cluster center to which each category of content feature belongs is re-determine as the initial content feature vector corresponding to the cluster center to which the category of content feature belongs.

Before training the content detection model in the next iteration, the adjusted content feature vector corresponding to the cluster center to which each category of content feature belongs is re-determined as the initial content feature vector corresponding to the cluster center to which the corresponding category of content feature belongs. For example, the re-determined initial content feature vectors corresponding to the cluster centers to which each category of content feature belong are a2, b2, c2 and d2, respectively. Moreover, the adjusted content feature vectors of the second multimedia data are (a2, b2, c2, d2) and continue to be used for training the content detection model.

B5: After the training of the content detection model is completed, the content feature vectors corresponding to a plurality of cluster centers of each category of content feature are obtained.

After the training of the content detection model is completed, the adjustment of the content feature vector of the second multimedia data is also completed. For example, the content feature vectors of the second multimedia data after the adjustment are (aa, bb, cc, dd). Based on the content feature vector of the second multimedia data obtained lastly, the content feature vectors corresponding to the cluster centers to which respective categories of content feature belong are obtained. For example, the cluster centers to which respective categories of content feature belong are 01, 06, 09 and 13, and the corresponding content feature vectors are aa, bb, cc, dd. It can be understood that the content feature vector corresponding to the cluster center to which each category of content feature belongs is the content feature vector after the adjustment.

In one or more embodiments, the content detection model in the present application is trained in real time, that is, after re-collecting the second multimedia data, the content detection model is retrained. Thus, before retraining the content detection model, the content feature vector of the second multimedia data is obtained. At this time, the content feature vector of the second multimedia data is still obtained from the initial content feature vector corresponding to the cluster center to which each category of content feature of the second multimedia data belongs.

It is understandable that the cluster centers to which some categories of content feature in the re-collected second multimedia data belong may change. If the cluster centers to which some categories of content feature belong are used for the first time, the initial content feature vectors corresponding to these cluster centers are randomly initialized feature vectors. For example, if the cluster center to which the OCR text category of content feature in the re-collected second multimedia data belongs changes to 07, its corresponding initial content feature vector is a randomly initialized feature vector, such as el. The cluster center to which the video/image category of content feature belongs changes to 14, its corresponding initial content feature vector is also a randomly initialized feature vector, such as f1. If it is not used for the first time, the initial content feature vectors corresponding to these cluster centers are the content feature vectors corresponding to the cluster centers obtained after the last adjustment. For example, if the cluster center to which the title text category of content feature of the second multimedia data belongs is still 01, its corresponding initial content feature vector is aa. The cluster center to which the ASR text category of content feature belongs is still 09, its corresponding initial content feature vector is cc.

Therefore, after training the content detection model with a batch of a large amount of the second multimedia data, since the cluster centers to which the respective categories of the content feature vectors of respective batches of second multimedia data belong may change, it is possible to finally obtain the content feature vectors corresponding respectively to the plurality of cluster centers of each category of content feature. For example, the content feature vectors corresponding respectively to the plurality of cluster centers (such as 01, 02, 03, 04, 05) of the title text category of content feature are obtained. The content feature vectors corresponding respectively to the plurality of cluster centers (such as 06, 07 and 08) corresponding to the OCR text category of content feature are obtained. The content feature vectors corresponding respectively to the plurality of cluster centers (such as 09, 10, 11 and 12) corresponding to the ASR text category of content feature are obtained. The content feature vectors corresponding respectively to the plurality of cluster centers (such as 13, 14, and 15) corresponding to the video/image category of content feature are obtained.

Based on the contents of B1-B5, the initial content feature vector corresponding to the cluster center to which each category of content feature of the second multimedia data belongs is determined as the content feature vector of the second multimedia data. During the training process of the content detection model, the content feature vector of the second multimedia data is adjusted, that is, the initial content feature vector corresponding to the cluster center to which each category of content feature of the second multimedia data belongs is adjusted. This allows the content feature vector of the second multimedia data to represent the second multimedia data with higher accuracy, and can more accurately characterize the second multimedia data. Furthermore, it can also make the trained content detection model more accurate.

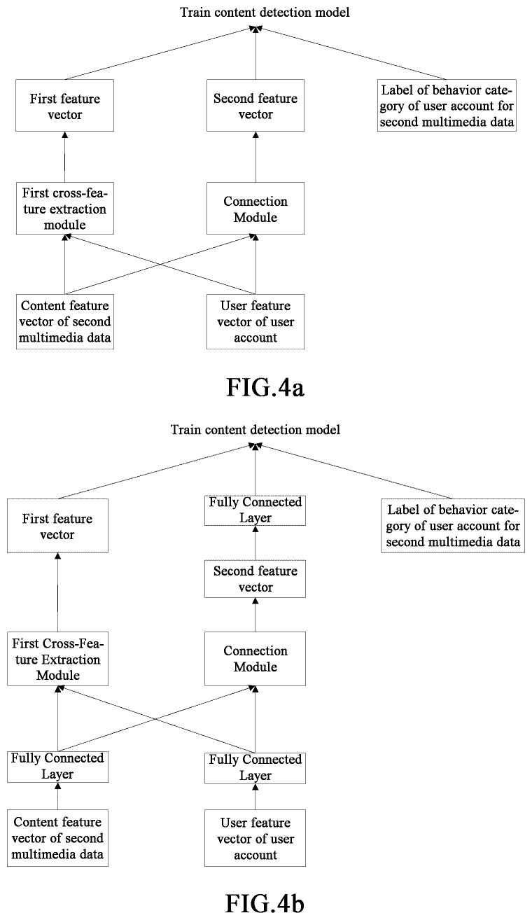

Referring to FIG. 4a, which is a schematic diagram of a content detection model provided by the embodiment of the present application. As shown in FIG. 4a, in one or more embodiments, the content detection model comprises a first cross-feature extraction module and a connection module. Based on this, in a possible implementation, the embodiment of the present application provides an implementation for training the content detection model using the content feature vector of the second multimedia data, the user feature vector of the user account, and the label of the behavior category of the user account for the second multimedia data in S204. The implementation comprises:

C1: the content feature vector of the second multimedia data and the user feature vector of the user account are input into the first cross-feature extraction module, so that the first cross- feature extraction module can extract the cross-feature from the content feature vector of the second multimedia data and the user feature vector of the user account, to obtain the first feature vector.

The first cross-feature extraction module is configured to extract cross-feature from the input feature vector. Compared with the independent content feature vector of the second multimedia data and the user feature vector of the user account, the first feature vector can contain more information on the feature vector. Therefore, using the first feature vector to train the content detection model can achieve better training results. In addition, using the first feature vector to train the content detection model, the model will learn the degree to which the user feature vectors of different user accounts affect the content feature vectors of different second multimedia data, and explore the differences in preferences of different user accounts for different second multimedia data.

In order to facilitate the processing of feature vectors, the dimensions of the feature vectors are changed. As shown in FIG. 4b, FIG. 4b is a schematic diagram of another content detection model provided by the embodiment of the present application. In one or more embodiments, the content detection model also comprises a plurality of fully connected layers. The content feature vector of the second multimedia data is first input into the fully connected layer, to change the dimension of the content feature vector of the second multimedia data, and then the content feature vector of the second multimedia data with the changed dimension is input into the first cross-feature extraction module. Similarly, the user feature vector of the user account is first input into the fully connected layer, to change the dimension of the user feature vector of the user account, and then the user feature vector of the user account with the changed dimension is input into the first cross-feature extraction module. So that the first cross-feature extraction module extracts the cross-feature from the input feature vector to obtain the first feature vector.

It is understandable that the embodiment of the present application does not limit the number and composition structure of the fully connected layers, which can be set based on actual conditions.

C2: the content feature vector of the second multimedia data and the user feature vector of the user account are input into the connection module, so that the connection module connects the content feature vector of the second multimedia data and the user feature vector of the user account, to obtain the second feature vector.

It can be understood that the connection module is used for cascade concat, and a concat operation is performed on the content feature vector of the second multimedia data and the user feature vector of the user account, to obtain the second feature vector.

In one or more embodiments, the content detection model further comprises a fully connected layer. The obtained second feature vector is input into the fully connected layer to re- obtain the second feature vector.

C3: the content detection model is trained using the first feature vector, the second feature vector, and the label of the behavior category of the user account for the second multimedia data.

After obtaining the first feature vector and the second feature vector, the content detection model is trained using the first feature vector, the second feature vector, and the label of the behavior category of the user account for the second multimedia data.

Based on the contents of C1-C3, based on the content feature vector of the second multimedia data and the user feature vector of the user account, the first feature vector is obtained using the first cross-feature extraction module, and the second feature vector is obtained using the connection module. Furthermore, the content detection model is trained using the first feature vector, the second feature vector, and the label of the behavior category of the user account for the second multimedia data. The user feature vector of the user account is used in the process of training the model, so that the trained content detection model can output the prediction result, with a high accuracy, of the behavior category of the target user account for the target multimedia data.

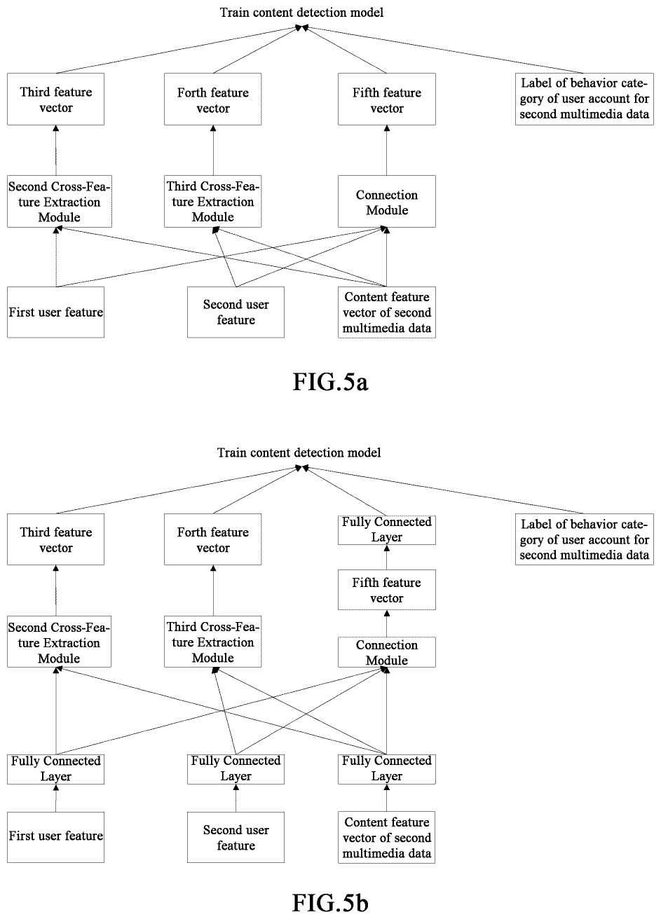

Referring to FIG. 5a, which is a schematic diagram of another content detection model provided in the embodiment of the present application. As shown in FIG. 5a, in one or more embodiments, the content detection model comprises a second cross-feature extraction module, a third cross-feature extraction module, and a connection module. Based on this, the embodiment of the present application provides an implementation of training the content detection model using the content feature vector of the second multimedia data, the user feature vector of the user account, and the label of the behavior category of the user account for the second multimedia data in S204. The implementation comprises:

D1: the content feature vector of the second multimedia data and the first user feature are input into the second cross-feature extraction module. So that the second cross-feature extraction module extracts the cross-feature from the content feature vector of the second multimedia data and the first user feature, to obtain the third feature vector.

Since the user feature vector of the user account can be composed of the first user feature of the user account and the second user feature of the user account, on the basis that the content detection model comprises the second cross-feature extraction module, the third cross- feature extraction module and the connection module, the content feature vector of the second multimedia data and the first user feature can be input into the second cross-feature extraction module, to obtain the third feature vector.

The third feature vector contains information on the content feature vector of the second multimedia data and information on the first user feature, and the third feature vector is a combination of the content feature vector of the second multimedia data and the first user feature. Compared with the independent content feature vector of the second multimedia data and the first user feature, the third feature vector can contain more information about the feature vector. The third feature vector can be used to train the content detection model to achieve better training effect. In addition, by using the third feature vector to train the content detection model, the model will learn the degree to which the users with different first user features affect the content feature vectors of different second multimedia data, and explore the differences in preferences of different user accounts for different second multimedia data.

As shown in FIG. 5b, FIG. 5b is a schematic diagram of another content detection model provided in the embodiment of the present application. In one or more embodiments, as shown in FIG. 5b, the content detection model also comprises a plurality of fully connected layers, and the content feature vector of the second multimedia data is first input into the fully connected layer, to change the dimension of the content feature vector of the second multimedia data, and then the content feature vector of the second multimedia data with the changed dimension is input into the second cross-feature extraction module. Similarly, the first user feature is first input into the fully connected layer, to change the dimension of the first user feature, and then the first user feature with the changed dimension is input into the second cross-feature extraction module, so that the second cross-feature extraction module extracts the cross-feature from the input feature vector, to obtain the third feature vector.

D2: the content feature vector of the second multimedia data and the second user feature are input into the third cross-feature extraction module, so that the third cross-feature extraction module extracts the cross-feature from the content feature vector of the second multimedia data and the second user feature, to obtain the fourth feature vector.

It is understandable that, compared with the independent content feature vector of the second multimedia data and the second user feature, the fourth feature vector can contain more information on the feature vector. Therefore, using the fourth feature vector to train the content detection model can achieve better training results. In addition, by using the fourth feature vector to train the content detection model, the model will learn the degree to which the users with different second user features affect the content feature vectors of different second multimedia data, and explore the differences in preferences of different user accounts for different second multimedia data.

In one or more embodiments, the content detection model further comprises a plurality of fully connected layers, the content feature vector of the second multimedia data is first input into the fully connected layer, to change the dimension of the content feature vector of the second multimedia data, and then the content feature vector of the second multimedia data with the changed dimension is input into the third cross-feature extraction module. Similarly, the second user feature is first input into the fully connected layer, to change the dimension of the second user feature, and then the second user feature with the changed dimension is input into the third cross-feature extraction module, so that the third cross-feature extraction module extracts the cross-feature from the input feature vector, to obtain the fourth feature vector.

D3: the content feature vector of the second multimedia data, the first user feature and the second user feature are input into the connection module, so that the connection module connects the content feature vector of the second multimedia data, the first user feature and the second user feature, to obtain the fifth feature vector.

In one or more embodiments, the content detection model further comprises a fully connected layer, and the obtained fifth feature vector is input into the fully connected layer, to re- obtain the fifth feature vector.

D4: the content detection model is trained using the third feature vector, the fourth feature vector, the fifth feature vector and the label of the behavior category of the user account for the second multimedia data.

After obtaining the third feature vector, the fourth feature vector, and the fifth feature vector, the content detection model is trained using the third feature vector, the fourth feature vector, the fifth feature vector, and the label of the behavior category of the user account for the second multimedia data.

Based on the contents of D1-D4, based on the content feature vector of the second multimedia data and the first user feature, the third feature vector is obtained using the second cross-feature extraction module. Based on the content feature vector of the second multimedia data and the second user feature, the third feature vector is obtained using the third cross-feature extraction module, and the fourth feature vector is obtained using the connection module. Based on the content feature vector of the second multimedia data, the first user feature and the second user feature, the fifth feature vector is obtained using the connection module. Furthermore, the content detection model is trained using the third feature vector, the fourth feature vector, the fifth feature vector and the label of the behavior category of the user account for the second multimedia data. The user feature vector of the user account is used in the process of training the model, so that the trained content detection model can output the prediction result, with a high accuracy, of the behavior category of the target user account for the target multimedia data.

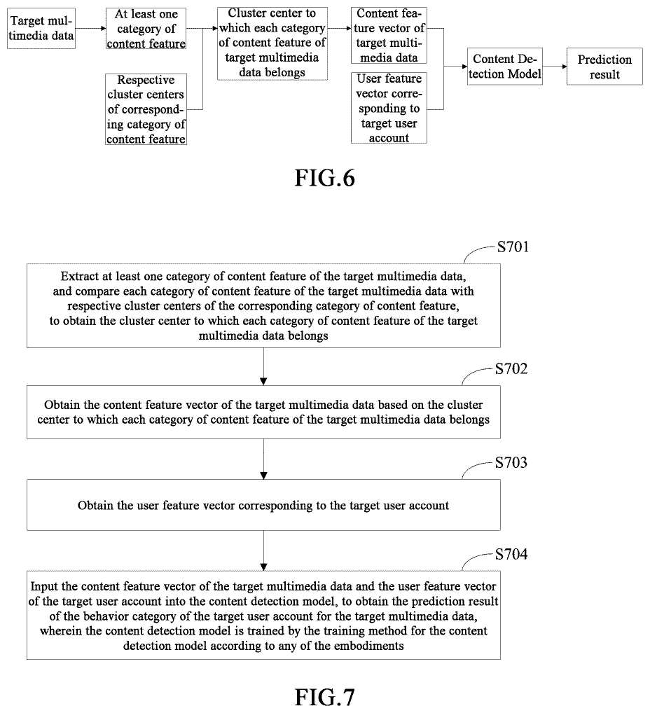

After the training of the content detection model is completed, the content detection model can be used to detect the content to obtain the prediction result of the behavior category of the target user account for the target multimedia data. In order to facilitate understanding of the content detection method provided by the embodiment of the present application, the following is illustrated with reference to the scenario example shown in FIG. 6. Referring to FIG. 6, which is schematic framework diagram of an exemplary application scenario provided in the embodiment of the present application.

As shown in FIG. 6, in an implementation, the target multimedia data is obtained firstly, and the target multimedia data is the multimedia data to be detected. Then, the at least one category of content feature of the target multimedia data is extracted, and each category of content feature of the target multimedia data is compared with the respective cluster centers of the corresponding category of content feature, to obtain the cluster center to which each category of content feature of the target multimedia data belongs. Furthermore, the content feature vector of the target multimedia data can be obtained based on the cluster center to which each category of content feature of the target multimedia data belongs. The content feature vector of the target multimedia data is used to input into the trained content detection model.

In addition, it is also necessary to obtain the user feature vector corresponding to the target user account. The user feature vector corresponding to the target user account is used to input into the trained content detection model.

Finally, the content feature vector of the target multimedia data and the user feature vector of the target user account are input into the content detection model, and the prediction result of the behavior category of the target user account for the target multimedia data can be obtained. The content detection model is trained using the training method for the content detection model of any of the above embodiments.

It should be noted that in the embodiment of the present application, the user feature vector of the target user account does not involve sensitive information on the user, and the user feature vector of the target user account is obtained and used after authorization by the user. In one example, before obtaining the user feature vector of the target user account, the corresponding interface displays prompt information related to obtaining an authorization of using data, and the user determines whether to agree to the authorization based on the prompt information.

Those skilled in the art will appreciate that the framework diagram shown in FIG. 6 is only an example in which the embodiment of the present application can be implemented. The scope of the embodiment of the present application is not limited by any aspect of the framework.

In order to facilitate understanding of the content detection method provided by the embodiment of the present application, the content detection method provided in the embodiment of the present application is illustrated below with reference to the accompanying drawings.

Referring to FIG. 7, which is a flow chart of a content detection method provided in the embodiment of the present application. As shown in FIG. 7, the method may comprise S701-S704:

S701: at least one category of content feature of the target multimedia data is extracted, each category of content feature of the target multimedia data is compared with the respective cluster centers of the corresponding category of content feature, and the cluster center to which each category of content feature of the target multimedia data belongs is obtained.

It can be understood that the target multimedia data is the multimedia data to be detected, and the target multimedia data may be one piece of multimedia data or a plurality of pieces of multimedia data.

In one or more embodiments, a pre-trained model may be used to extract at least one category of content feature of target multimedia data.

After obtaining at least one category of content feature of the target multimedia data, each category of content feature of the target multimedia data is compared with the respective cluster centers of the corresponding category of content feature, to obtain the cluster center to which each category of content feature of the target multimedia data belongs. Wherein the respective cluster centers of the corresponding category of content feature is obtained based on the first multimedia data in S201.

S702: the content feature vector of the target multimedia data is obtained based on the cluster center to which each category of content feature of the target multimedia data belongs.

The obtained content feature vector of the target multimedia data is used to input into the trained content detection model for prediction.

It can be understood that S702 in the embodiment of the present application is similar to S202 in the above embodiment. For the sake of simplicity, it will not be described in detail here. The detailed information can be referred to the description in the above embodiment.

S703: the user feature vector corresponding to the target user account is obtained.

The obtained user feature vector corresponding to the target user account is used to input into the trained content detection model for prediction. The user account for detecting the target multimedia data by the content detection model is the target user account, that is, the target user account is a user account that performs behavior such as clicks, likes, and completion of playback for the target multimedia data. That is, how much the target user account prefers the target multimedia data is detected, and then whether the target multimedia data is high-quality multimedia data is analyzed based on the result of the detection.

As an optional example, the target user account is a random user account.

For each multimedia data, its target user is biased, that is, only some user accounts are interested. Thus, the target user account is the user account that may be interested in the target multimedia data. The user account that may be interested in the target multimedia data is used to evaluate the target multimedia data, this makes the evaluation result obtained more reasonable and accurate. Based on this, as another optional example, the target user account can be determined by training the user account recall model.

In an implementation, before obtaining the user feature vector corresponding to the target user account, the content detection method provided by the embodiment of the present application further comprises:
inputting the content feature vector of the target multimedia data into the user account recall model, to obtain the target user account corresponding to the target multimedia data.

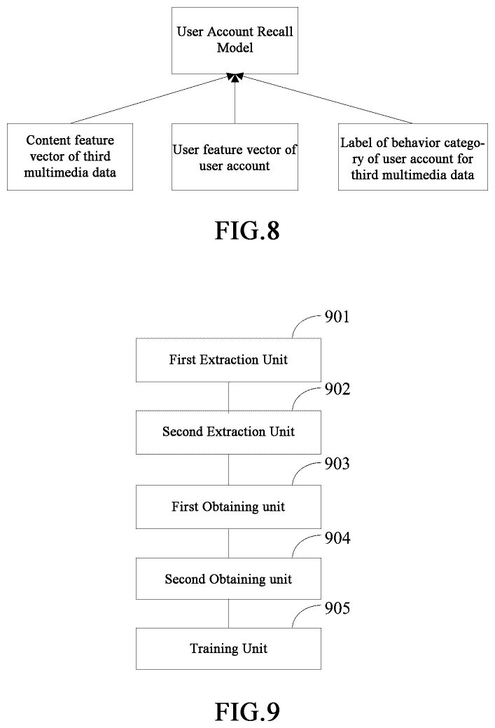

Referring to FIG. 8, which is a diagram of training the user account recall model provided in the embodiment of the present application. The user account recall model is trained based on the content feature vector of the third multimedia data, the user feature vector of the user account, and the label of the behavior category of the user account for the third multimedia data. During the training process of the user account recall model, the behavior category of the user account for the third multimedia data can be predicted by calculating the similarity between the content feature vector of the third multimedia data and the user feature vector of the user account. And the predicted behavior category and the label of the behavior category are compared to train the user account recall model. As an optional example, the user account recall model is implemented by a deep neural network. As an optional example, the third multimedia data is the third advertisement multimedia data.

It should be noted that in the embodiment of the present application, the user feature vector of the user account and the label of the behavior category of the user account for the third multimedia data do not involve sensitive information on the user. The user feature vector of the user account and the label of the behavior category of the user account for the third multimedia data are obtained and used after authorization by the user. In one example, before obtaining the user feature vector of the user account and the label of the behavior category of the user account for the third multimedia data, the corresponding interface displays prompt information related to obtain an authorization of using data, and the user determines whether to agree to the authorization based on the prompt information.

In a possible implementation, the embodiment of the present application provides an implementation for obtaining the user feature vector corresponding to the target user account. The implementation comprises the following steps.
E1: the user information of the target user account is collected, and the first user feature of the target user account is generated based on the user information of the target user account.
E2: the second user feature of the target user account is obtained by pre-training.
E3: the first user feature of the target user account and the second user feature of the target user account are used as the user feature vector of the target user account.

E1-E3 in the embodiment of the present application are similar to A1-A3 in the above embodiment. For the sake of simplicity, they will not be described in detail herein. The detailed information can be referred to the description in the above embodiment.

It should be noted that in the embodiment of the present application, the user information of the target user account, the first user feature of the target user account, and the second user feature of the target user account do not involve the sensitive information on the user. The user information of the target user account, the first user feature of the target user account, and the second user feature of the target user account are obtained and used after the authorization by the user. In one example, before obtaining the user information of the target user account, the first user feature of the target user account, and the second user feature of the target user account, the corresponding interface displays prompt information related to obtain an authorization of using data, and the user determines whether to agree to the authorization based on the prompt information.

S704: the content feature vector of the target multimedia data and the user feature vector of the target user account are input into the content detection model, to obtain the prediction result of the behavior category of the target user for the target multimedia data. The content detection model is trained using the training method for the content detection model of any of the above embodiments.

After obtaining the content feature vector of the target multimedia data and the user feature vector of the target user account, the content feature vector of the target multimedia data and the user feature vector of the target user account can be input into the content detection model to obtain the predict result of the behavior category of the target user account for the target multimedia data. The obtained prediction result represents the degree of the preference of the target user account for the target multimedia data.

In a possible implementation, the content detection method provided in the embodiment of the present application further comprises: calculating the evaluation result of the content detection for the target multimedia data based on the prediction result of the behavior category of the target user account for the target multimedia data. As an optional example, when the prediction result of the behavior category of the target user account for the target multimedia data is an evaluation value, the evaluation result of the content detection of the target multimedia data is the average of the evaluation values of each behavior category. Wherein the evaluation value of each behavior category can be the average of the evaluation values for a plurality of target user accounts for the behavior category. For example, for a certain piece of the target multimedia data, the average value of the prediction result for the likes-behavior category of a plurality of target user accounts is 0.7. The average value of the prediction result for the clicks-behavior category of a plurality of target user accounts is 0.4. If there are only the above two behavior categories, the evaluation result of the content detection of the target multimedia data is obtained as 0.55.

It is understandable that the obtained evaluation result of the content detection of the target multimedia data is a quantitative representation of the degree of the preference of the target user account for the target multimedia data, and is also a quantitative representation of whether the target multimedia data is high-quality target multimedia data. For example, when the evaluation result of the content detection is greater than 0.5, it means that the target user account prefers the target multimedia data, and the target multimedia data is high-quality multimedia data.

In addition, when the first user feature of the target user account and the second user feature of the target user account are used as the user feature vector of the target user account, the embodiment of the present application provides an implementation of inputting the content feature vector of the target multimedia data and the user feature vector of the target user account into the content detection model to obtain the prediction result of the behavior category of the target user account for the target multimedia data. The implementation comprises:
inputting the content feature vector of the target multimedia data, the first user feature of the target user account, and the second user feature of the target user account into the content detection model, to obtain the prediction result of the behavior category of the target user account for the target multimedia data.

Based on the contents of S701-S704, it can be known that when checking the target content, at least one category of content feature of the target multimedia data is first extracted, and each category of content feature of the target multimedia data is compared with the respective cluster centers of the corresponding category of content feature, to obtain the cluster center to which each category of content feature of the target multimedia data belongs. The content feature vector of the target multimedia data is obtained, based on the cluster center to which each category of content feature of the target multimedia data belongs. In addition, the user feature vector corresponding to the target user account is obtained. Furthermore, the content feature vector of the target multimedia data and the user feature vector of the target user account are input into the content detection model to obtain the prediction result of the behavior category of the target user account for the target multimedia data. In this way, the target multimedia data can be evaluated using the content detection model without delivering the target multimedia data, thereby reducing the delivery cost. In addition, since the influence of the user account on the evaluation of the multimedia data is taken into account during the training process of the content detection model, the prediction result for the target multimedia data by the content detection model is more reasonable and accurate.

Based on the training method for the content detection model provided by the above method embodiment, the embodiment of the present application further provides a training apparatus for the content detection model. The training apparatus for the content detection model will be described below with reference to the accompanying drawings.

Referring to FIG. 9, which is a schematic structural diagram of the training apparatus for the content detection model provided by the embodiment of the present application. As shown in FIG. 9, the training apparatus for the content detection model comprises:
a first extraction unit 901, configured to extract at least one category of content feature of the first multimedia data, and cluster each category of content feature of the first multimedia data to obtain a plurality of cluster centers of each category of content feature;
a second extraction unit 902, configured to extract at least one category of content feature of the second multimedia data, and compare each category of content feature of the second multimedia data with the respective cluster centers of the corresponding category of content feature, to obtain the cluster center to which each category of content feature of the second multimedia data belongs;
a first obtaining unit 903, configured to obtain the content feature vector of the second multimedia data based on the cluster center to which each category of content feature of the second multimedia data belongs;
a second obtaining unit 904, configured to obtain the user feature vector of the user account;
a training unit 905, configured to train the content detection model using the content feature vector of the second multimedia data, the user feature vector of the user account, and the label of behavior category of the user account for the second multimedia data, wherein the content detection model is used to output a prediction result of the behavior category of the target user account for the target multimedia data.

In a possible implementation, the first obtaining unit 903 comprises:
a first acquisition sub-unit, configured to obtain the initial content feature vector corresponding to the cluster center to which each category of content feature of the second multimedia data belongs;
a first determination sub-unit, configured to determine the initial content feature vector corresponding to the cluster center to which each category of content feature of the second multimedia data belongs, as the content feature vector of the second multimedia data.

In a possible implementation, the apparatus further comprises:
an adjustment unit, configured to adjust the content feature vector of the second multimedia data during the process of training the content detection model;
a determination unit, configured to re-determine the adjusted content feature vector corresponding to the cluster center to which each category of content feature belongs, as the initial content feature vector corresponding to the cluster center to which the category of the content feature belongs;
a third obtaining unit, configured to obtain content feature vectors corresponding respectively to the plurality of cluster centers of each category of content feature after the training of the content detection model.

In a possible implementation, the apparatus further comprises:
a calculation unit, configured to calculate the content feature vectors corresponding respectively to the plurality of cluster centers of each category of content feature based on each category of content feature.

The first obtaining unit 903 comprises:
a second determination sub-unit, configured to determine the content feature vector corresponding to the cluster center to which each category of content feature of the second multimedia data belongs, as the content feature vector of the second multimedia data.

In a possible implementation, the second obtaining unit 904 comprises:
a collection sub-unit, configured to collect the user information of the user account, and generate the first user feature of the user account based on the user information of the user account;
a second acquisition sub-unit, configured to obtain the second user feature of the user account obtained by pre-training;
a third determination sub-unit, configured to use the first user feature of the user account and the second user feature of the user account as the user feature vector of the user account.

In a possible implementation, the content detection model comprises a first cross-feature extraction module and a connection module, and the training unit 905 comprises:
a first input sub-unit, configured to input the content feature vector of the second multimedia data and the user feature vector of the user account into the first cross-feature extraction module, so that the first cross-feature extraction module extracts the cross-feature from the content feature vector of the second multimedia data and the user feature vector of the user account, to obtain a first feature vector;
a second input sub-unit, configured to input the content feature vector of the second multimedia data and the user feature vector of the user account into the connection module, so that the connection module connects the content feature vector of the second multimedia data and the user feature vector of the user account to obtain a second feature vector;
a first training sub-unit, configured to train the content detection model using the first feature vector, the second feature vector, and the label of the behavior category of the user account for the second multimedia data.

In a possible implementation, the content detection model comprises a second cross-feature extraction module, a third cross-feature extraction module and a connection module, and the training unit 905 comprises:
a third input sub-unit, configured to input the content feature vector of the second multimedia data and the first user feature into the second cross-feature extraction module, so that the second cross-feature extraction module extracts the cross-feature from the content feature vector of the second multimedia data and the first user feature to obtain a third feature vector;
a fourth input sub-unit, configured to input the content feature vector of the second multimedia data and the second user feature into the third cross-feature extraction module, so that the third cross-feature extraction module extracts the cross-feature from the content feature vector of the second multimedia data and the second user feature to obtain a fourth feature vector;
a fifth input sub-unit, configured to input the content feature vector of the second multimedia data, the first user feature and the second user feature into the connection module, so that the connection module connects the content feature vector of the second multimedia data, the first user feature and the second user feature to obtain a fifth feature vector;
a second training sub-unit, configured to train the content detection model using the third feature vector, the fourth feature vector, the fifth feature vector and the label of the behavior category of the user account for the second multimedia data.

Based on the content detection method provided by the above method embodiment, the embodiment of the present application also provides a content detection apparatus. The content detection apparatus will be described below with reference to the accompanying drawings.

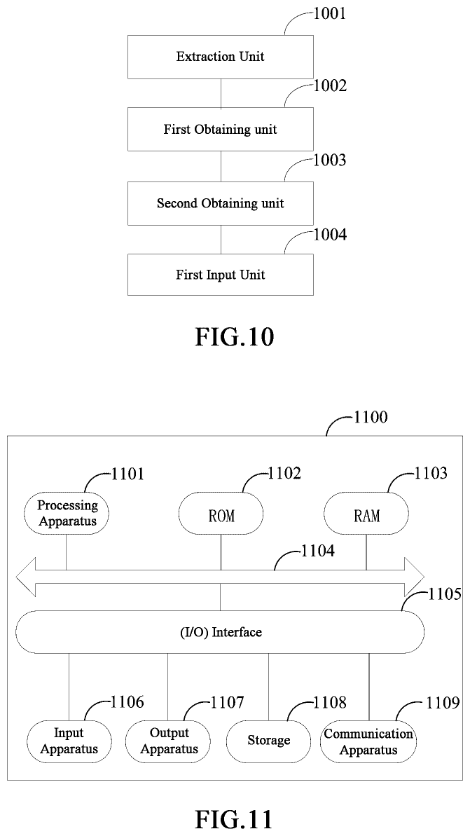

Referring to FIG. 10, which is a schematic structural diagram of a content detection apparatus provided in the embodiment of the present application. As shown in FIG. 10, the content detection apparatus comprises:
an extraction unit 1001, configured to extract at least one category of content feature of the target multimedia data, compare each category of content feature of the target multimedia data with the respective cluster centers of the respective category of the content feature, to obtain the cluster center to which each category of content feature of the target multimedia data belongs;
a first obtaining unit 1002, configured to obtain the content feature vector of the target multimedia data based on the cluster center to which each category of content feature of the target multimedia data belongs;
a second obtaining unit 1003, configured to obtain the user feature vector corresponding to the target user account;
a first input unit 1004, configured to input the content feature vector of the target multimedia data and the user feature vector of the target user account into the content detection model, to obtain the prediction result of the behavior category of the target user account for the target multimedia data, wherein the content detection model is trained based on any of the above training methods for the content detection model.

In a possible implementation, the apparatus further comprises:
a calculation unit, configured to calculate an evaluation result of the content detection of the target multimedia data based on the prediction result of the behavior category of the target user account for the target multimedia data.

In a possible implementation, the apparatus further comprises:
a second input unit, configured to, before obtaining the user feature vector corresponding to the target user account, input the content feature vector of the target multimedia data into the user account recall model to obtain the target user account corresponding to the target multimedia data; wherein the user account recall model is trained based on the content feature vector of the third multimedia data, the user feature vector of the user account, and the label of the behavior category of the user account for the third multimedia data.

In a possible implementation, the second obtaining unit 1003 comprises:
a collection sub-unit, configured to collect user information of the target user account, and generate the first user feature of the target user account based on the user information of the target user account;
a first acquisition sub-unit, configured to obtain the second user feature of the target user account obtained by pre-training;
a determination sub-unit, configured to use the first user feature of the target user account and the second user feature of the target user account as the user feature vector of the target user account.

The first input unit 1004 is specifically configured to:
input the content feature vector of the target multimedia data, the first user feature of the target user account, and the second user feature of the target user account into the content detection model, to obtain the prediction result of the behavior category of the target user account for the target multimedia data.

Based on the training method for the content detection model and the content detection method provided in the above method embodiments, the present application also provides an electronic device. The electronic device comprises: one or more processors; a storage storing one or more programs thereon which, when executed by the one or more processors cause the one or more processors to implement the training method for the content detection model according to any of the above embodiments, or the content detection method according to any of the above embodiments.

Referring to FIG. 11, which illustrates a schematic structural diagram of an electronic device 1100 suitable for implementing the embodiment of the present application. The terminal device in the embodiment of the present application may comprise, but is not limited to, mobile terminals such as mobile phones, laptop computers, digital broadcast receivers, Personal Digital Assistant (PDA), portable android device (PAD), Portable Media Player (PMP), vehicle-mounted terminals (such as vehicle-mounted navigation terminals), etc., and fixed terminals such as digital television (TV), desktop computers, etc. The electronic device shown in FIG. 11 is only an example and should not impose any limitations on the function and scope of use of the embodiment of the present application.

As shown in FIG. 11, the electronic device 1100 may comprise a processing apparatus (e.g., central processing unit, graphics processor, etc.) 1101, which executes various appropriate actions and processes based on programs stored in read-only memory (ROM) 1102 or programs loaded from storage 1106 into random access memory (RAM) 1103. The various programs and data required for the operation of the electronic device 1100 are also stored in the RAM 1103. The processing apparatus 1101, the ROM 1102 and the RAM 1103 are connected to each other via a bus 1104. An input/output (I/O) interface 1105 is also connected to the bus 1104.

Typically, the following apparatus may be connected to the I/O interface 1105: an input apparatus 1106 comprising, for example, a touch screen, a touchpad, a keyboard, a mouse, a camera, a microphone, an accelerometer, a gyroscope, etc.; an output apparatus 1107 comprising, for example, a liquid crystal display (LCD), a speaker, a vibrator, etc.; a storage 1106 comprising, for example, a magnetic tape, a hard disk, etc.; and a communication apparatus 1109. The communication apparatus 1109 may allow the electronic device 1100 to communicate wirelessly or wired with other devices to exchange data. Although FIG. 11 shows the electronic device 1100 with various apparatus, it should be understood that it is not required to implement or have all the apparatus shown. More or fewer apparatus may be implemented or have alternatively.

In particular, according to the embodiment of the present application, the process described above with reference to the flowchart can be implemented as a computer software program. For example, the embodiment of the present application comprises a computer program product, which comprises a computer program carried on a non-transitory computer-readable medium, and the computer program comprises a program code for executing the method shown in the flowchart. In such an embodiment, the computer program can be downloaded and installed from the network through the communication apparatus 1109, or installed from the storage 1106, or installed from the ROM 1102. When the computer program is executed by the processing apparatus 1101, the above-mentioned functions defined in the method of the embodiment of the present application are executed.

The electronic device provided by the embodiment of the present application belongs to the same inventive concept as the training method for the content detection model and the content detection method provided by the above embodiment. Technical details that are not described in detail in this embodiment can be referred to the above embodiment, and this embodiment has the same beneficial effects as the above embodiment.

Based on the training method for the content detection model and the content detection method provided by the above method embodiments, embodiments of the present application provide a computer-readable medium having a computer program stored thereon that, when executed by the processor, implements the training method for the content detection model according to any of the above embodiments, or the content detection method according to any of the above embodiments.

It should be noted that the computer-readable medium mentioned in the present application may be a computer-readable signal medium or a computer-readable storage medium, or any combination of the above two. The computer-readable storage medium may be, for example, but is not limited to, an electrical, magnetic, optical, electromagnetic, infrared, or semi-conductive system, apparatus or device, or any combination thereof. More specific examples of computer-readable storage media may comprise, but are not limited to: an electrical connection having one or more wires, a portable computer disk, a hard drive, random access memory (RAM), read only memory (ROM), erasable programmable read-only memory (EPROM or flash), optical fiber, portable compact disk read-only memory (CD-ROM), optical storage device, magnetic storage device, or any suitable combination of the above. In the present application, a computer-readable storage medium may be any tangible medium that contains or stores a program for use by or in connection with an instruction execution system, apparatus, or device. In the present application, the computer-readable signal medium may comprise a data signal propagated in baseband or as part of a carrier wave, which carry computer-readable program code. Such propagated data signals may take a variety of forms, comprising but not limited to electromagnetic signals, optical signals, or any suitable combination of the above. A computer-readable signal medium may also be any computer-readable medium other than a computer-readable storage medium, which can send, propagate, or transmit programs for use by instruction execution systems, apparatus, or devices, or in combination with them. The program code embodied on a computer-readable medium may be transmitted using any suitable medium, comprising but not limited to: wire, optical cable, radio frequency (RF), etc., or any suitable combination of the above.

In some embodiments, the client and server can communicate using any currently known or future developed network protocol such as HyperText Transfer Protocol (HTTP), and can interconnect with any form or medium of digital data communication (such as communication networks). Examples of communications networks comprise local area networks (“LAN”), wide area networks (“WAN”), the Internet (e.g., the Internet), and end-to-end networks (e.g., ad hoc end-to-end networks), as well as any networks which is currently known or developed in the future.

The above-mentioned computer-readable medium may be comprised in the above-mentioned electronic device; it may also exist independently without being assembled into the electronic device.

The above-mentioned computer-readable medium carries one or more programs, which, when executed by the electronic device, cause the electronic device to execute the training method for the content detection model mentioned above or the content detection method mentioned above.

Computer program code for performing the operations of the present application may be written in one or more programming languages, comprising, but not limited to, object-oriented programming languages—such as Java, Smalltalk, C++, and the conventional procedural programming languages—such as “C” or similar programming languages. The program code may execute entirely on the user's computer, partly on the user's computer, as a stand-alone software package, partly on the user's computer and partly on a remote computer or entirely on the remote computer or server. In scenarios involving a remote computer, the remote computer can be connected to the user's computer through any kind of network, comprising a local area network (LAN) or a wide area network (WAN), or the remote computer can be connected to an external computer (such as connect via the internet using internet service providers).

The flowchart and block diagram in the figures illustrate the possible architecture, functions, and operations of the system, methods, and computer program products according to various embodiments of the present application. In this regard, each block in the flowchart or block diagram may represent a module, program segment, or portion of code that contains one or more executable instructions for implementing a specified logical function. It should also be noted that, in some alternative implementations, the functions noted in the block may occur in a different order than those noted in the figures. For example, two blocks shown one after another may actually be executed substantially in parallel, or they may sometimes execute in the reverse order, depending on the functionality involved. It will also be noted that each block of the block diagram and/or flowchart, and combinations of blocks in the block diagram and/or flowchart, can be implemented by dedicated hardware-based systems that perform the specified functions or operations, or can be implemented by a combination of dedicated hardware and computer instructions.

The units involved in the embodiment of the present application may be implemented by software or hardware. The name of a unit/module does not limit the unit itself in some cases. For example, a voice data acquisition module may also be described as a “data acquisition module”.

The functions described above herein may be performed at least in part by one or more hardware logic components. For example, without limitation, exemplary types of hardware logic components that may be used comprise: a field programmable gate array (FPGA), an application specific integrated circuit (ASIC), an application specific standard product (ASSP), a system on chip (SOC), a complex programmable logic device (CPLD), and the like.

In the context of the present application, a machine-readable medium may be a tangible medium that may contain or store a program for use by or in conjunction with an instruction execution system, apparatus, or device. A machine-readable medium may be a machine-readable signal medium or a machine-readable storage medium. A machine-readable medium may comprise, but is not limited to, an electronic, magnetic, optical, electromagnetic, infrared, or semi-conductive system, apparatus, or device, or any suitable combination of the above. A more specific example of a machine-readable storage medium may comprise an electrical connection based on one or more lines, a portable computer disk, a hard disk, a random access memory (RAM), a read-only memory (ROM), an erasable programmable read-only memory (EPROM or flash), an optical fiber, a portable compact disk read-only memory (CD-ROM), an optical storage device, a magnetic storage device, or any suitable combination of the above.

According to one or more embodiment of the present application, [Example 1] provides a training method for a content detection model, extracting at least one category of content feature of first multimedia data, clustering each category of content feature of the first multimedia data to obtain a plurality of cluster centers of each category of content feature; wherein the method comprises:
extracting at least one category of content feature of second multimedia data, and comparing each category of content feature of the second multimedia data with respective cluster centers of a corresponding category of content feature, to obtain a cluster center to which each category of content feature of the second multimedia data belongs;
obtaining a content feature vector of the second multimedia data based on the cluster center to which each category of content feature of the second multimedia data belongs;
obtaining a user feature vector of a user account; and
training the content detection model using the content feature vector of the second multimedia data, the user feature vector of the user account, and a label of a behavior category of the user account for the second multimedia data, wherein the content detection model is used to output a prediction result of a behavior category of a target user account for target multimedia data.

According to one or more embodiment of the present application, [Example 2] provides a training method for a content detection model, wherein the obtaining the content feature vector of the second multimedia data based on the cluster center to which each category of content feature of the second multimedia data belongs comprises:
obtaining an initial content feature vector corresponding to the cluster center to which each category of content feature of the second multimedia data belongs;
determining the initial content feature vector corresponding to the cluster center to which each category of content feature of the second multimedia data belongs as the content feature vector of the second multimedia data.

According to one or more embodiment of the present application, [Example 3] provides a training method for a content detection model, the method further comprising:
adjusting the content feature vector of the second multimedia data during a process of training the content detection model;
re-determining the adjusted content feature vector corresponding to the cluster center to which each category of content feature belongs as an initial content feature vector corresponding to the cluster center to which the category of content feature belongs; and
after the training of the content detection model, obtaining content feature vectors corresponding respectively to the plurality of cluster centers of each category of content feature.

According to one or more embodiment of the present application, [Example 4] provides a training method for a content detection model, the method further comprising:
calculating content feature vectors corresponding respectively to the plurality of cluster centers of each category of content feature based on each category of content feature;
wherein the obtaining the content feature vector of the second multimedia data based on the cluster center to which each category of content feature of the second multimedia data belongs comprises:
determining a content feature vector corresponding to the cluster center to which each category of content feature of the second multimedia data belongs as the content feature vector of the second multimedia data.

According to one or more embodiment of the present application, [Example 5] provides a training method for a content detection model, wherein the obtaining the user feature vector of the user account comprises:
collecting user information of the user account, and generating a first user feature of the user account based on the user information of the user account;
obtaining a second user feature of the user account obtained by pre-training; and using the first user feature of the user account and the second user feature of the user account as the user feature vector of the user account.

According to one or more embodiment of the present application, [Example 6] provides a training method for a content detection model, wherein the content detection model comprises a first cross-feature extraction module and a connection module, and wherein the training the content detection model using the content feature vector of the second multimedia data, the user feature vector of the user account, and the label of the behavior category of the user account for the second multimedia data comprises:
inputting the content feature vector of the second multimedia data and the user feature vector of the user account into the first cross-feature extraction module, to cause the first cross-feature extraction module to extract a cross-feature from the content feature vector of the second multimedia data and the user feature vector of the user account, to obtain a first feature vector;
inputting the content feature vector of the second multimedia data and the user feature vector of the user account into the connection module, to cause the connection module to connect the content feature vector of the second multimedia data and the user feature vector of the user account, to obtain a second feature vector; and
training the content detection model using the first feature vector, the second feature vector, and the label of the behavior category of the user account for the second multimedia data.

According to one or more embodiment of the present application, [Example 7] provides a training method for a content detection model, wherein the content detection model comprises a second cross-feature extraction module, a third cross-feature extraction module, and a connection module, wherein the training the content detection model using the content feature vector of the second multimedia data, the user feature vector of the user account, and the label of the behavior category of the user account for the second multimedia data comprises:
inputting the content feature vector of the second multimedia data and the first user feature into the second cross-feature extraction module to cause the second cross-feature extraction module to extract a cross-feature from the content feature vector of the second multimedia data and the first user feature, to obtain a third feature vector;
inputting the content feature vector of the second multimedia data and the second user feature into the third cross-feature extraction module, to cause the third cross-feature extraction module to extract a cross-feature from the content feature vector of the second multimedia data and the second user feature, to obtain a fourth feature vector;
inputting the content feature vector of the second multimedia data, the first user feature, and the second user feature into the connection module, to cause the connection module to connect the content feature vector of the second multimedia data, the first user feature, and the second user feature, to obtain a fifth feature vector; and
training the content detection model using the third feature vector, the fourth feature vector, the fifth feature vector, and the label of the behavior category of the user account for the second multimedia data.

According to one or more embodiment of the present application, [Example 8] provides a content detection method, the method comprises:
extracting at least one category of content feature of target multimedia data, and comparing each category of content feature of the target multimedia data with respective cluster centers of a corresponding category of content feature, to obtain a cluster center to which each category of content feature of the target multimedia data belongs;
obtaining a content feature vector of the target multimedia data based on the cluster center to which each category of content feature of the target multimedia data belongs;
obtaining a user feature vector corresponding to a target user account; and
inputting the content feature vector of the target multimedia data and the user feature vector of the target user account into a content detection model, to obtain a prediction result of a behavior category of the target user account for the target multimedia data, wherein the content detection model is trained according to any of the above training method for the content detection model.

According to one or more embodiment of the present application, [Example 9] provides a content detection method, the method further comprises:
calculating an evaluation result of content detection for the target multimedia data based on the prediction result of the behavior category of the target user account for the target multimedia data.

According to one or more embodiment of the present application, [Example 10] provides a content detection method, the method further comprises before obtaining the user feature vector corresponding to the target user account:
inputting the content feature vector of the target multimedia data into a user account recall model, to obtain a target user account corresponding to the target multimedia data; wherein the user account recall model is trained based on a content feature vector of third multimedia data, a user feature vector of a user account, and a label of a behavior category of the user account for the third multimedia data.

According to one or more embodiment of the present application, [Example 11] provides a content detection method, wherein the obtaining the user feature vector corresponding to the target user account comprises:
collecting user information of the target user account, and generating a first user feature of the target user account based on the user information of the target user account;
obtaining a second user feature of the target user account obtained by pre-training; and using the first user feature of the target user account and the second user feature of the target user account as the user feature vector of the target user account.

The inputting the content feature vector of the target multimedia data and the user feature vector of the target user account into the content detection model to obtain the prediction result of the behavior category of the target user account for the target multimedia data comprises:
inputting the content feature vector of the target multimedia data, the first user feature of the target user account, and the second user feature of the target user account into the content detection model, to obtain the prediction result of the behavior category of the target user account for the target multimedia data.

According to one or more embodiment of the present application, [Example 12] provides a training apparatus for a content detection model. The training apparatus comprises:
a first extraction unit, configured to extract at least one category of content feature of first multimedia data, and cluster each category of content feature of the first multimedia data to obtain a plurality of cluster centers of each category of content feature;
a second extraction unit, configured to extract at least one category of content feature of second multimedia data, and compare each category of content feature of the second multimedia data with respective cluster centers of a corresponding category of content feature to obtain a cluster center to which each category of content feature of the second multimedia data belongs;
a first obtaining unit, configured to obtain a content feature vector of second multimedia data based on the cluster center to which each category of content feature of the second multimedia data belongs;
a second obtaining unit, configured to obtain a user feature vector of a user account; and
a training unit, configured to train the content detection model using the content feature vector of the second multimedia data, the user feature vector of the user account, and a label of a behavior category of the user account for the second multimedia data, wherein the content detection model is used to output a prediction result of a behavior category of a target user account for target multimedia data.

According to one or more embodiment of the present application, [Example 13] provides a training apparatus for a content detection model, wherein the first obtaining unit comprises:
a first acquisition sub-unit, configured to obtain an initial content feature vector corresponding to the cluster center to which each category of content feature of the second multimedia data belongs;
a first determination sub-unit, configured to determine the initial content feature vector corresponding to the cluster center to which each category of content feature of the second multimedia data belongs, as a content feature vector of the second multimedia data.

According to one or more embodiment of the present application, [Example 14] provides a training apparatus for a content detection model, and the apparatus further comprises:
an adjustment unit, configured to adjust the content feature vector of the second multimedia data during a process of training the content detection model;
a determination unit, configured to re-determine the adjusted content feature vector corresponding to the cluster center to which each category of content feature belongs, as the initial content feature vector corresponding to the cluster center to which the category of the content feature belongs;
a third obtaining unit, configured to obtain content feature vectors corresponding to the plurality of cluster centers of each category of content feature after the training of the content detection model.

According to one or more embodiment of the present application, [Example 15] provides a training apparatus for a content detection model, and the apparatus further comprises:
a calculation unit, configured to calculate the content feature vectors corresponding to the plurality of cluster centers of each category of content feature based on each category of content feature,

The first obtaining unit comprises:
a second determination sub-unit, configured to determine the content feature vector corresponding to the cluster center to which each category of content feature of the second multimedia data belongs, as the content feature vector of the second multimedia data.

According to one or more embodiment of the present application, [Example 16] provides a training apparatus for a content detection model, and wherein the second obtaining unit comprises:
a collection sub-unit, configured to collect user information of a user account, and generate a first user feature of the user account based on the user information of the user account;
a second acquisition sub-unit, configured to obtain a second user feature of the user account obtained by pre-training;
a third determination sub-unit, configured to use the first user feature of the user account and the second user feature of the user account as a user feature vector of the user account.

According to one or more embodiment of the present application, [Example 17] provides a training apparatus for a content detection model, wherein the content detection model comprises a first cross-feature extraction module and a connection module, and wherein the training unit comprises:
a first input sub-unit, configured to input the content feature vector of the second multimedia data and the user feature vector of the user account into the first cross-feature extraction module, to cause the first cross-feature extraction module to extract a cross-feature from the content feature vector of the second multimedia data and the user feature vector of the user account, to obtain a first feature vector;
a second input sub-unit, configured to input the content feature vector of the second multimedia data and the user feature vector of the user account into the connection module, to cause the connection module to connect the content feature vector of the second multimedia data and the user feature vector of the user account, to obtain a second feature vector;
a first training sub-unit, configured to train the content detection model using the first feature vector, the second feature vector, and the label of the behavior category of the user account for the second multimedia data.

According to one or more embodiment of the present application, [Example 18] provides a training apparatus for a content detection model, wherein the content detection model comprises a second cross-feature extraction module, a third cross-feature extraction module, and a connection module, and wherein the training unit comprises:
a third input sub-unit, configured to input the content feature vector of the second multimedia data and the first user feature into the second cross-feature extraction module, to cause the second cross-feature extraction module to extract a cross-feature from the content feature vector of the second multimedia data and the first user feature to obtain a third feature vector;
a fourth input sub-unit, configured to input the content feature vector of the second multimedia data and the second user feature into the third cross-feature extraction module, to cause the third cross-feature extraction module to extract a cross-feature from the content feature vector of the second multimedia data and the second user feature, to obtain a fourth feature vector;
a fifth input sub-unit, configured to input the content feature vector of the second multimedia data, the first user feature, and the second user feature into the connection module, to cause the connection module to connect the content feature vector of the second multimedia data, the first user feature, and the second user feature, to obtain a fifth feature vector;
a second training sub-unit, configured to train the content detection model using the third feature vector, the fourth feature vector, the fifth feature vector and the label of the behavior category of the user account for the second multimedia data.

According to one or more embodiment of the present application, [Example 19] provides a content detection apparatus comprising:
an extraction unit, configured to extract at least one category of content feature of target multimedia data, and compare each category of content feature of the target multimedia data with respective cluster centers of the corresponding category of content feature, to obtain a cluster center to which each category of content feature of the target multimedia data belongs;
a first obtaining unit, configured to obtain a content feature vector of the target multimedia data based on the cluster center to which each category of content feature of the target multimedia data belongs;
a second obtaining unit, configured to obtain a user feature vector corresponding to a target user account;
a first input unit, configured to input the content feature vector of the target multimedia data and the user feature vector of the target user account into a content detection model to obtain a prediction result of a behavior category of the target user account for the target multimedia data, wherein the content detection model is trained according to any of the above training method for the content detection model.

According to one or more embodiment of the present application, [Example 20] provides a content detection apparatus comprising:
a calculation unit, configured to calculate an evaluation result of the content detection for the target multimedia data based on the prediction result of the behavior category of the target user account for the target multimedia data.

According to one or more embodiment of the present application, [Example 21] provides a content detection apparatus. The content detection apparatus comprises:
a second input unit, configured to input, before obtaining the user feature vector corresponding to the target user account, the content feature vector of the target multimedia data into a user account recall model to obtain a target user account corresponding to the target multimedia data; wherein the user account recall model is trained based on a content feature vector of third multimedia data, a user feature vector of the user account, and the label of the behavior category of the user account for the third multimedia data.

According to one or more embodiment of the present application, [Example 22] provides a content detection apparatus, wherein the second obtaining unit comprises:
a collection sub-unit, configured to collect user information of a target user account, and generate a first user feature of the target user account based on the user information of the target user account;
a first acquisition sub-unit, configured to obtain a second user feature of the target user account obtained by pre-training;
a determination sub-unit, configured to use the first user feature of the target user account and the second user feature of the target user account as a user feature vector of the target user account.

The first input unit is specifically configured to:
input the content feature vector of the target multimedia data, the first user feature of the target user account, and the second user feature of the target user account into a content detection model, to obtain a prediction result of a behavior category of the target user account for the target multimedia data.

According to one or more embodiment of the present application, [Example 23] provides an electronic device, comprising:
one or more processors;
a storage storing one or more programs thereon which, when executed by the one or more processors, cause the one or more processors to implement any of the above training method for the content detection model or any of the above content detection method.

According to one or more embodiment of the present application, [Example 24] provides a computer-readable medium having a computer program stored thereon that, when executed by a processor, causes the processor to implement any of the above training method for the content detection model or any of the above content detection method.

According to one or more embodiment of the present application, [Example 25] provides a computer program product that, when running on a computer, causes the computer to implement any of the above training method for the content detection model or any of the above content detection method.

It should be noted that the various embodiments in this specification are described in a progressive manner, and each embodiment focuses on the differences from other embodiments, and the same or similar parts between the various embodiments can be referred to each other. For the system or apparatus disclosed in the embodiment, since it corresponds to the method disclosed in the embodiment, the description is relatively simple, and the relevant parts can be referred to the description of the method.

It should be understood that in the present application, “at least one (item)” means one or more, and “plurality” means two or more. “And/or” is used to describe the association relationship of associated objects, indicating that three relationships may exist. For example, “A and/or B” can represent only A exists, only B exists, and A and B exist at the same time, where A and B can be singular or plural. The character “/” generally indicates that the associated objects are in an “or” relationship. “At least one of the following” or similar expressions refers to any combination of these items, comprising any combination of single or plural items. For example, at least one of a, b or c can represent a, b, c, “a and b”, “a and c”, “b and c”, or “a and b and c”, where a, b, c can be single or multiple.

It should also be noted that in the present application, relational terms such as first and second are only used to distinguish one entity or operation from another entity or operation, and do not necessarily require or imply that any actual relationship or order between these entities or operations. Furthermore, the terms “include,” “comprise,” or any other variations thereof are intended to cover a non-exclusive inclusion such that a process, method, article, or device that comprises a list of elements comprises not only those elements, but also other elements that are not explicitly listed, or elements inherent to the process, method, article or device. Without further limitation, an element defined by the statement “comprises a . . . ” does not exclude the existence of other identical elements in the process, method, article, or device that comprises the said elements.

The steps of the method or algorithm described in conjunction with the embodiments disclosed herein may be implemented directly using hardware, a software module executed by a processor, or a combination of the two. The software module may be placed in a random access memory (RAM), a memory, a read-only memory (ROM), an electrically programmable ROM, an electrically erasable programmable ROM, a register, a hard disk, a removable disk, a CD-ROM, or any other form of storage medium known in the art.

The above description of the disclosed embodiments enables those skilled in the art to implement or use the present application. Various modifications to these embodiments will be apparent to those skilled in the art, and the general principles defined herein may be implemented in other embodiments without departing from the spirit or scope of the present application. Therefore, the present application will not be limited to the embodiments shown herein, but will conform to the widest scope consistent with the principles and novel features disclosed herein.

What is claimed is:

1. A training method for a content detection model, wherein at least one category of content feature of first multimedia data is extracted, each category of content feature of the first multimedia data is clustered to obtain a plurality of cluster centers of each category of content feature, and the method comprises:
extracting at least one category of content feature of second multimedia data, and comparing each category of content feature of the second multimedia data with respective cluster centers of a corresponding category of content feature, to obtain a cluster center to which each category of content feature of the second multimedia data belongs;
obtaining a content feature vector of the second multimedia data based on the cluster center to which each category of content feature of the second multimedia data belongs;
obtaining a user feature vector of a user account; and
training the content detection model using the content feature vector of the second multimedia data, the user feature vector of the user account, and a label of a behavior category of the user account for the second multimedia data, wherein the content detection model is used to output a prediction result of a behavior category of a target user account for target multimedia data.

2. The method according to claim 1, wherein the obtaining the content feature vector of the second multimedia data based on the cluster center to which each category of content feature of the second multimedia data belongs comprises:
obtaining an initial content feature vector corresponding to the cluster center to which each category of content feature of the second multimedia data belongs; and
determining the initial content feature vector corresponding to the cluster center to which each category of content feature of the second multimedia data belongs as the content feature vector of the second multimedia data.

3. The method according to claim 2, further comprising:
adjusting the content feature vector of the second multimedia data during a process of training the content detection model;
re-determining the adjusted content feature vector corresponding to the cluster center to which each category of content feature belongs as the initial content feature vector corresponding to the cluster center to which the category of content feature belongs; and
after the training of the content detection model, obtaining content feature vectors corresponding respectively to the plurality of cluster centers of each category of content feature.

4. The method according to claim 1, further comprising:
calculating content feature vectors corresponding respectively to the plurality of cluster centers of each category of content feature based on each category of content feature;
wherein the obtaining the content feature vector of the second multimedia data based on the cluster center to which each category of content feature of the second multimedia data belongs comprises:
determining a content feature vector corresponding to the cluster center to which each category of content feature of the second multimedia data belongs as the content feature vector of the second multimedia data.

5. The method according to claim 1, wherein the obtaining the user feature vector of the user account comprises:
collecting user information of the user account, and generating a first user feature of the user account based on the user information of the user account;
obtaining a second user feature of the user account obtained by pre-training; and
using the first user feature of the user account and the second user feature of the user account as the user feature vector of the user account.

6. The method according to claim 1, wherein the content detection model comprises a first cross-feature extraction module and a connection module, and wherein the training the content detection model using the content feature vector of the second multimedia data, the user feature vector of the user account, and the label of the behavior category of the user account for the second multimedia data comprises:
inputting the content feature vector of the second multimedia data and the user feature vector of the user account into the first cross-feature extraction module, to cause the first cross-feature extraction module to extract a cross-feature from the content feature vector of the second multimedia data and the user feature vector of the user account, to obtain a first feature vector;
inputting the content feature vector of the second multimedia data and the user feature vector of the user account into the connection module, to cause the connection module to connect the content feature vector of the second multimedia data and the user feature vector of the user account, to obtain a second feature vector; and
training the content detection model using the first feature vector, the second feature vector, and the label of the behavior category of the user account for the second multimedia data.

7. The method according to claim 5, wherein the content detection model comprises a second cross-feature extraction module, a third cross-feature extraction module, and a connection module, wherein the training the content detection model using the content feature vector of the second multimedia data, the user feature vector of the user account, and the label of the behavior category of the user account for the second multimedia data comprises:
inputting the content feature vector of the second multimedia data and the first user feature into the second cross-feature extraction module, to cause the second cross-feature extraction module to extract a cross-feature from the content feature vector of the second multimedia data and the first user feature, to obtain a third feature vector;
inputting the content feature vector of the second multimedia data and the second user feature into the third cross-feature extraction module, to cause the third cross-feature extraction module to extract a cross-feature from the content feature vector of the second multimedia data and the second user feature, to obtain a fourth feature vector;
inputting the content feature vector of the second multimedia data, the first user feature, and the second user feature into the connection module, to cause the connection module to connect the content feature vector of the second multimedia data, the first user feature, and the second user feature, to obtain a fifth feature vector; and
training the content detection model using the third feature vector, the fourth feature vector, the fifth feature vector, and the label of the behavior category of the user account for the second multimedia data.

8. A content detection method, comprising:
extracting at least one category of content feature of target multimedia data, and comparing each category of content feature of the target multimedia data with respective cluster centers of a corresponding category of content feature, to obtain a cluster center to which each category of content feature of the target multimedia data belongs;
obtaining a content feature vector of the target multimedia data based on the cluster center to which each category of content feature of the target multimedia data belongs;
obtaining a user feature vector corresponding to a target user account; and
inputting the content feature vector of the target multimedia data and the user feature vector of the target user account into a content detection model, to obtain a prediction result of a behavior category of the target user account for the target multimedia data, wherein the content detection model is trained by the training method for the content detection model according claim 1.

9. The method according to claim 8, further comprising:
calculating an evaluation result of content detection for the target multimedia data based on the prediction result of the behavior category of the target user account for the target multimedia data.

10. The method according to claim 8, wherein the method further comprises before obtaining the user feature vector corresponding to the target user account:
inputting the content feature vector of the target multimedia data into a user account recall model, to obtain a target user account corresponding to the target multimedia data; wherein the user account recall model is trained based on a content feature vector of third multimedia data, a user feature vector of a user account, and a label of a behavior category of the user account for the third multimedia data.

11. The method according to claim 8, wherein the obtaining the user feature vector corresponding to the target user account comprises:
collecting user information of the target user account, and generating a first user feature of the target user account based on the user information of the target user account;
obtaining a second user feature of the target user account obtained by pre-training; and
using the first user feature of the target user account and the second user feature of the target user account as the user feature vector of the target user account;
wherein the inputting the content feature vector of the target multimedia data and the user feature vector of the target user account into the content detection model to obtain the prediction result of the behavior category of the target user account for the target multimedia data comprises:
inputting the content feature vector of the target multimedia data, the first user feature of the target user account, and the second user feature of the target user account into the content detection model, to obtain the prediction result of the behavior category of the target user account for the target multimedia data.

12-13. (canceled)

14. An electronic device, wherein at least one category of content feature of first multimedia data is extracted, each category of content feature of the first multimedia data is clustered to obtain a plurality of cluster centers of each category of content feature, and the electronic device comprises:
one or more processors; and
a storage storing one or more programs thereon which, when executed by the one or more processors, cause the one or more processors to:
extract at least one category of content feature of second multimedia data, and compare each category of content feature of the second multimedia data with respective cluster centers of a corresponding category of content feature, to obtain a cluster center to which each category of content feature of the second multimedia data belongs;
obtain a content feature vector of the second multimedia data based on the cluster center to which each category of content feature of the second multimedia data belongs;
obtain a user feature vector of a user account; and
train the content detection model using the content feature vector of the second multimedia data, the user feature vector of the user account, and a label of a behavior category of the user account for the second multimedia data, wherein the content detection model is used to output a prediction result of a behavior category of a target user account for target multimedia data.

15. A non-transitory computer-readable medium, having a computer program stored thereon that, when executed by a processor, implements the training method for the content detection model according to claim 1.

16. (canceled)

17. The electronic device according to claim 14, wherein the one or more programs causing the one or more processors to obtain the content feature vector of the second multimedia data based on the cluster center to which each category of content feature of the second multimedia data belongs further causes the processor to:
obtain an initial content feature vector corresponding to the cluster center to which each category of content feature of the second multimedia data belongs; and
determine the initial content feature vector corresponding to the cluster center to which each category of content feature of the second multimedia data belongs as the content feature vector of the second multimedia data.

18. The electronic device according to claim 17, the one or more programs further cause the one or more processors to:
adjust the content feature vector of the second multimedia data during a process of training the content detection model;
re-determine the adjusted content feature vector corresponding to the cluster center to which each category of content feature belongs as the initial content feature vector corresponding to the cluster center to which the category of content feature belongs; and
after training the content detection model, obtain content feature vectors corresponding respectively to the plurality of cluster centers of each category of content feature.

19. The electronic device according to claim 14, the one or more programs further cause the one or more processors to:
calculate content feature vectors corresponding respectively to the plurality of cluster centers of each category of content feature based on each category of content feature;
wherein the one or more programs causing the one or more processors to obtain the content feature vector of the second multimedia data based on the cluster center to which each category of content feature of the second multimedia data belongs further causes the processor to:
determine a content feature vector corresponding to the cluster center to which each category of content feature of the second multimedia data belongs as the content feature vector of the second multimedia data.

20. The electronic device according to claim 14, wherein the one or more programs causing the one or more processors to obtain the user feature vector of the user account further causes the processor to:
collect user information of the user account, and generate a first user feature of the user account based on the user information of the user account;
obtain a second user feature of the user account obtained by pre-training; and
use the first user feature of the user account and the second user feature of the user account as the user feature vector of the user account.

21. The electronic device according to claim 14, wherein the content detection model comprises a first cross-feature extraction module and a connection module, and wherein the one or more programs causing the one or more processors to train the content detection model using the content feature vector of the second multimedia data, the user feature vector of the user account, and the label of the behavior category of the user account for the second multimedia data further causes the processor to:
input the content feature vector of the second multimedia data and the user feature vector of the user account into the first cross-feature extraction module, to cause the first cross-feature extraction module to extract a cross-feature from the content feature vector of the second multimedia data and the user feature vector of the user account, to obtain a first feature vector;
input the content feature vector of the second multimedia data and the user feature vector of the user account into the connection module, to cause the connection module to connect the content feature vector of the second multimedia data and the user feature vector of the user account, to obtain a second feature vector; and
train the content detection model using the first feature vector, the second feature vector, and the label of the behavior category of the user account for the second multimedia data.

22. The electronic device according to claim 14, wherein the content detection model comprises a second cross-feature extraction module, a third cross-feature extraction module, and a connection module, wherein the one or more programs causing the one or more processors to train the content detection model using the content feature vector of the second multimedia data, the user feature vector of the user account, and the label of the behavior category of the user account for the second multimedia data further causes the processor to:
input the content feature vector of the second multimedia data and the first user feature into the second cross-feature extraction module, to cause the second cross-feature extraction module to extract a cross-feature from the content feature vector of the second multimedia data and the first user feature, to obtain a third feature vector;
input the content feature vector of the second multimedia data and the second user feature into the third cross-feature extraction module, to cause the third cross-feature extraction module to extract a cross-feature from the content feature vector of the second multimedia data and the second user feature, to obtain a fourth feature vector;
input the content feature vector of the second multimedia data, the first user feature, and the second user feature into the connection module, to cause the connection module to connect the content feature vector of the second multimedia data, the first user feature, and the second user feature, to obtain a fifth feature vector; and
train the content detection model using the third feature vector, the fourth feature vector, the fifth feature vector, and the label of the behavior category of the user account for the second multimedia data.

23. A non-transitory computer-readable medium, having a computer program stored thereon that, when executed by a processor, implements the content detection method according to claim 8.
